(19) United States
(12) Patent Application Publication
(10) Pub. No.: US 2005/0177515 A1
(43) Pub. Date: Aug. 11, 2005

(54) Wi-Fi service delivery platform for retail service providers

(75) Inventors: Asawaree Kalavade, Stowe, MA (US); Kevin Jackson, Groton, MA (US); Jeremy Greene, Acton, MA (US); Eric Bomarsi, Northborough, MA (US)

Correspondence Address: WILMER CUTLER PICKERING HALE AND DORR LLP, 60 STATE STREET, BOSTON, MA, 02109, US

(73) Assignee: Tatara Systems, Inc., Acton, MA (US)

(21) Appl. No.: 10/871,413

(22) Filed: Jun. 18, 2004

Related U.S. Application Data
(60) Provisional application No. 60/542,515, filed on Feb. 6, 2004.

(51) Int. Cl. G06F 17/60

(52) U.S. Cl. 705/52; 713/200

(57) ABSTRACT

A method is provided for managing usage of a plurality of local area networks by a plurality of subscribers associated with a service provider. The subscribers have terminals for accessing the local area networks. The terminals each have a client program for communicating with a service provider network. For each subscriber desiring to access a local area network, the method includes: (a) receiving at a gateway at the service provider network a request for authenticating a subscriber desiring access to the local area network, the request containing subscriber credentials for the subscriber desiring access to the local area network; (b) authenticating the subscriber based on the subscriber credentials and information relating to the subscriber previously stored in a subscriber database; (c) authorizing the local area network to grant access to the subscriber when the subscriber is authenticated; (d) establishing a link between the gateway and a client program on a terminal operated by the subscriber; (e) collecting session information through the link; (f) receiving information on local area network usage by the subscriber; and (g) transmitting the information on local area network usage to a billing system for billing of usage by the subscriber.

### RELATED APPLICATION

The present application is based on and claims priority from U.S. Provisional Patent Application Ser. No. 60/542,515 filed on Feb. 6, 2004 and entitled “WI-FI SERVICE DELIVERY PLATFORM FOR RETAIL SERVICE PROVIDERS,” which is incorporated herein by reference in its entirety.

### BACKGROUND OF THE INVENTION

1. Field of the Invention

The present invention relates generally to data networks and, more particularly, to a delivery platform for providing public wireless LAN (i.e., “Wi-Fi”) service.

2. Description of Related Art

Wireless data technologies are used to provide Internet and other network access to mobile client devices such as, e.g., laptops and personal digital assistants (PDAs). For example, enterprises and universities are now widely deploying wireless local area networks (LANs) based on the IEEE 802.11 standard. Users with client devices such as laptops and PDAs use an 802.11 network interface card that provides them wireless access to the Internet. In addition to replacing traditional Ethernet-based local area networks, these wireless LANs are now also being deployed in novel settings. Of special interest is the increasing deployment of these 802.11 based networks in public spaces and hot spots such as, e.g., airports, convention centers, hotels, and even local coffee shops. These hotspots can provide Wi-Fi service at fast speeds.

Retail Wi-Fi service providers (i.e., service providers who own direct relationships with end users) are constantly challenged to excel at meeting the needs of their end users. These needs include, e.g., providing service coverage across key venues, a simple, a reliable and high-quality end user experience, enterprise-quality security in a public environment, access to a suite of local and global applications, enterprise-level management of end user usage and costs, and affordable pricing plans for enterprise and individual users.

A need exists for an improved Wi-Fi service delivery platform that can be used by retail service providers to deliver a broad set of Wi-Fi capabilities.

### BRIEF SUMMARY OF EMBODIMENTS OF THE INVENTION

In accordance with one or more embodiments of the invention, a method is provided for managing usage of a plurality of local area networks by a plurality of subscribers associated with a service provider. The subscribers have terminals for accessing the local area networks. The terminals each have a client program for communicating with a service provider network. For each subscriber desiring to access a local area network, the method includes: (a) receiving at a gateway at the service provider network a request for authenticating a subscriber desiring access to the local area network, the request containing subscriber credentials for the subscriber desiring access to the local area network; (b) authenticating the subscriber based on the subscriber credentials and information relating to the subscriber previously stored in a subscriber database; (c) authorizing the local area network to grant access to the subscriber when the subscriber is authenticated; (d) establishing a link between the gateway and a client program on a terminal operated by the subscriber; (e) collecting session information through the link; (f) receiving information on local area network usage by the subscriber; and (g) transmitting the information on local area network usage to a billing system for billing of usage by the subscriber.

In accordance with one or more embodiments of the invention, a gateway is provided for managing usage of a plurality of local area networks by a plurality of subscribers associated with a service provider. The subscribers have terminals for accessing the local area networks. The terminals each have a client program for communicating with the gateway. The gateway comprises a first interface module for communicating with the local area networks; a second interface module for communicating with client programs on terminals operated by subscribers accessing the local area networks; a third interface module for communicating with infrastructure of the service provider; and a session manager for receiving through the first interface module requests for authenticating subscribers desiring access to the local area networks. The requests contain subscriber credentials for the subscribers. The session manager authenticates subscribers based on their subscriber credentials and information relating to the subscribers previously stored in a subscriber database through the third interface module. The session manager authorizes local area networks through the first interface module to grant access to authenticated subscribers. The session manager also receives from the local area networks through the first interface module information on local area network usage by the subscribers. The session manager transmits the information on local area network usage to a billing system through the third interface module for billing of usage by the subscribers. The session manager also collects session information through the second interface module from the client programs on the terminals accessing the local area networks.

In accordance with one or more embodiments of the invention, a method of accessing one of a plurality of local area networks by a subscriber operating a terminal is provided. The subscriber is associated with a service provider. The method for accessing a local area network comprises the steps of: (a) transmitting to the local area network a request for accessing the local area network, the request including subscriber credentials for the subscriber, the local area network transmitting to a gateway at the service provider network a request containing the subscriber credentials for authenticating the subscriber, the gateway authenticating the subscriber based on the subscriber credentials and information relating to the subscriber previously stored in a subscriber database, the gateway authorizing the local area network to grant access to the subscriber when the subscriber is authenticated; (b) accessing the local area network when the subscriber is authorized to access the local area network; (c) establishing a link between a client program on the terminal operated by the subscriber and the gateway; and (d) transmitting session information through the link to the gateway.

These and other features will become readily apparent from the following detailed description wherein embodiments of the invention are shown and described by way of illustration. As will be realized, the invention is capable of other and different embodiments and its several details may be capable of modifications in various respects, all without departing from the invention. Accordingly, the drawings and description are to be regarded as illustrative in nature and not in a restrictive or limiting sense.

### BRIEF DESCRIPTION OF THE DRAWINGS

FIG. 1 is a simplified diagram of a Wi-Fi service delivery platform for retail service providers in accordance with one or more embodiments of the invention;

FIG. 2 is a simplified diagram of a Wi-Fi service delivery platform for wholesale service operators in accordance with one or more embodiments of the invention;

FIG. 3 is a simplified diagram of a Subscriber Gateway deployment in a GSM/GPRS network in accordance with one or more embodiments of the invention;

FIG. 4 is a simplified diagram of a Subscriber Gateway deployment in a CDMA/1xRTT network in accordance with one or more embodiments of the invention;

FIG. 5 is a is a simplified diagram of a Subscriber Gateway showing clustered deployment in accordance with one or more embodiments of the invention;

FIG. 6 is a simplified diagram of components of a Subscriber Gateway in accordance with one or more embodiments of the invention;

FIG. 7 is a is a simplified diagram of the system architecture of a Subscriber Gateway in accordance with one or more embodiments of the invention;

FIG. 8 is a simplified diagram of clustering of a Subscriber Gateway in accordance with one or more embodiments of the invention;

FIG. 9 is a simplified diagram of multi-site clustering at a Subscriber Gateway in accordance with one or more embodiments of the invention;

FIG. 10 is a simplified diagram of the software architecture of a Subscriber Gateway in accordance with one or more embodiments of the invention;

FIG. 11 is a simplified diagram of data formats used in the Subscriber Gateway in accordance with one or more embodiments of the invention;

FIG. 12 is a sample screenshot of a Location Configuration Screen on the Subscriber Gateway in accordance with one or more embodiments of the invention;

FIG. 13 is an illustration of a sample operation sequence of a Subscriber Gateway in accordance with one or more embodiments of the invention;

FIG. 14 is a sample screenshot of a Management Interface for the Subscriber Gateway in accordance with one or more embodiments of the invention;

FIG. 15 is a simplified diagram of SIM Authentication in accordance with one or more embodiments of the invention;

FIG. 16 is a simplified diagram of HTTP based SIM Authentication in accordance with one or more embodiments of the invention;

FIG. 17 is a simplified diagram of Credential Encryption in accordance with one or more embodiments of the invention;

FIG. 18 is a simplified diagram of clientless two stage authentication in accordance with one or more embodiments of the invention;

FIG. 19 is a simplified diagram of a Prepaid Operation in accordance with one or more embodiments of the invention;

FIG. 20 is a table illustrating various exemplary service plans;

FIG. 21 is a simplified diagram of subscriber authorization in accordance with one or more embodiments of the invention;

FIG. 22 is a simplified diagram of multi-session aggregation in accordance with one or more embodiments of the invention;

FIG. 23 is a simplified diagram of standards alignment in accordance with one or more embodiments of the invention;

FIG. 24 is a simplified diagram of synergy of the system with 3GPP in accordance with one or more embodiments of the invention;

FIG. 25 is a simplified diagram of components of the Service Manager in accordance with one or more embodiments of the invention;

FIG. 26 is a simplified diagram of the Service Manager architecture in accordance with one or more embodiments of the invention;

FIG. 27 is a simplified diagram of components of the Service Manager in accordance with one or more embodiments of the invention;

FIG. 28 is a simplified diagram of session termination in a service provider-owned network in accordance with one or more embodiments of the invention;

FIG. 29 is an illustration of flows associated with termination in a TELUS-owned network; and

FIG. 30 is a simplified diagram of session termination in a centralized partner-owned network.

### DETAILED DESCRIPTION OF PREFERRED EMBODIMENTS

The present application relates to a Wi-Fi Service Delivery Platform that includes components that can function independently or can work together to deliver a broad set of Wi-Fi capabilities. The platform accelerates the path to profitability for Wi-Fi service providers by enabling both retail and wholesale service providers to support roaming relationships profitably—or even become “virtual providers” of public Wi-Fi services—without sacrificing security, control or advanced capabilities.

The Wi-Fi Service Delivery Platform has components that serve the needs of both retail service providers and wholesale operators or aggregators in the public Wi-Fi services space.

Retail Solution

Retail service providers (i.e., providers who own direct relationships with end users) are constantly challenged to excel at meeting the needs of their end users. In the public Wi-Fi service market, these needs can include: providing service coverage across key venues, a simple, reliable and high-quality end user experience, enterprise-quality security in a public environment, access to a suite of local and global applications, enterprise-level management of end user usage and costs, and affordable pricing plans for enterprise and individual users.

These needs can sometimes run counter to one another. For example, broad coverage implies lots of roaming partners—but this can negatively impact the simplicity of the end user experience and security. Reliable, high-quality service can be facilitated by ownership of the backhaul—but this can ruin the economics of the business and make affordable pricing impossible. Access to applications can be enabled when the retail provider owns the applications and the customer is not running a VPN—but a single provider will never be able control all of the potential applications and enterprise customers will need a VPN to access corporate networks and applications.

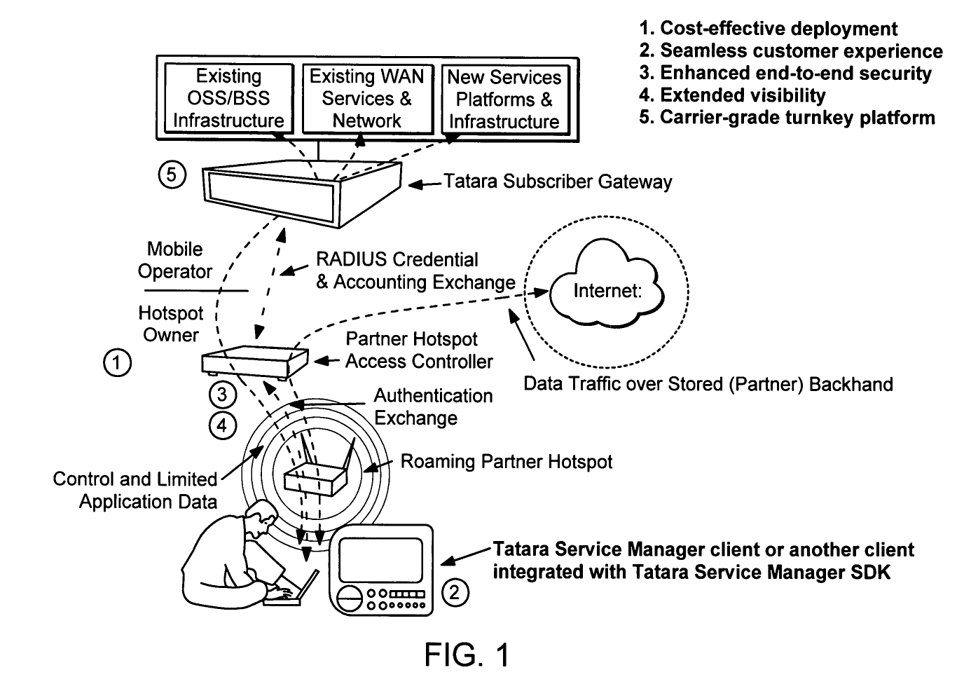

As shown in FIG. 1, a Wi-Fi Service Delivery Platform for retail service providers in accordance with one or more embodiments of the invention can include a Subscriber Gateway and a Service Manager.

The Subscriber Gateway is a centrally deployed and managed network device that controls multiple aspects of Wi-Fi services for a branded retail service provider. The Subscriber Gateway enables retail service providers to work with a broad set of roaming partners. It facilitates these partnerships through automated configuration and management capabilities and extends control by delivering a set of audit and visibility capabilities. A rich set of real-time presence, location and reachability capabilities work in conjunction with the Service Manager software to enable a branded retail service provider to maintain control over its end subscribers. This same capability can provide visibility into critical usage and performance data and ensures the consistent delivery of advanced services. The Subscriber Gateway does not require any proprietary hardware or software to be deployed on a partner network, nor does it require expensive backhaul changes to the network like many other alternative solutions.

The Service Manager is client software that runs on an end user's Wi-Fi enabled device such as a laptop or PDA. Issued by the retail service provider who owns the relationship with the end user, the Service Manager software can provide a carrier-branded user interface and secure connection management capability across multiple networks (e.g. Wi-Fi, GPRS, EDGE, 1xRTT). When deployed in conjunction with the Subscriber Gateway, the capabilities are extended to offer unique control, visibility, service integration and mobility features. The Service Manager can work with a broad set of networks and standards, enabling roaming onto partner networks without requiring these networks to conform to a single standard authentication mechanism.

Wholesale Solution

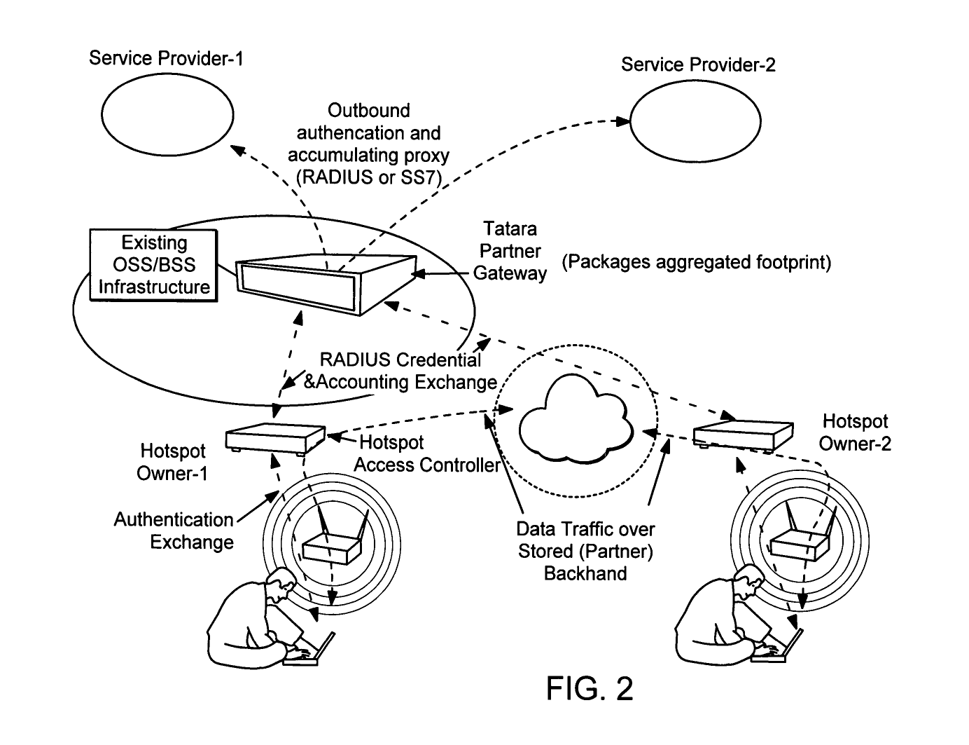

Wholesale operators—including aggregators—are challenged to maximize the value of their network assets through inbound roaming. Doing so requires balancing one's own needs with the needs of retail service provider ‘customers’ and local venue partners. From the wholesale operator's perspective, one core need is to support inbound roaming in a manner that is manageable, scalable, highly reliable and facilitates settlement with a range of partners. As shown in FIG. 2, Wi-Fi Service Delivery Platform for wholesale operators includes a Partner Gateway component.

The Partner Gateway is a centrally deployed and managed network device that facilitates partnerships and enables inbound roaming on Wi-Fi networks that a service provider owns. The Partner Gateway enables a network operator to configure and support roaming relationships easily and securely with a broad range of retail service provider partners. The system manages the real-time delivery of AAA or GSM MAP information to these partners from a central platform, supports delivery of local venue services and feeds roaming usage information to a wholesale billing/settlement platform or external clearinghouse. The Partner Gateway is a standards-based platform that does not require that the retail partners have any specific infrastructure other than a RADIUS server or terminating HLR.

Further details of the Wi-Fi Service Delivery Platform for wholesale operators are provided in U.S. patent application Ser. No. ______, entitled WI-FI SERVICE DELIVERY PLATFORM FOR WHOLESALE SERVICE PROVIDERS, (Attorney Docket No. 113-300-129) filed on even date herewith, which is incorporated by reference herein in its entirety.

As will be discussed in further detail below, a Wi-Fi service delivery platform for retail service providers in accordance with one or more embodiments of the invention includes a number of advantageous features including, e.g., carrier-grade reliability via a clustered and load balanced architecture, enhanced network management and alerting support via SNMP events, RAID support, and configurable backup and restore support.

Subscriber Gateway capabilities for retail service providers can include: (1) advanced service plan support allowing creation and enforcement of complex service plans around several parameters such as locations, connections, duration, and volume, (2) prepay support for authentication, monitoring, and management of prepaid sessions, (3) aggregation and mediation of multi-session records for complex service plans, including prepaid and postpaid sessions, (4) enhanced security through end-to-end credential encryption, (5) LDAP interface to external subscriber databases for flexible access to subscriber information, (6) ODBC interface to export records to external systems for easy reporting and data manipulation by operators, and (7) wizards to simplify configuration of roaming relationships.

Service Manager capabilities for retail service providers can include: (1) “Dashboard” architecture, providing integrated client for enhanced usability, (2) customizable profiles, allowing service provider, Wi-Fi operator, and user customization of network, security, and application settings, (3) tethered phone support, (4) NIC driver management, allowing management of up to-date versions of Wi-Fi NIC drivers, (5) conflicting application management, allowing detection and management of conflicting applications on end-user terminals, and (6) authentication enhancements to support multiple roaming network configurations.

More specifically, advantages of service delivery platforms in accordance with one or more embodiments of the invention can include those grouped into four categories:
(a) overall architecture innovation;
(b) features enabled by the combination of the Service Manager (client) and Subscriber Gateway (server);
(c) capabilities of the Subscriber Gateway; and
(d) capabilities of the Service Manager.

Architecture Innovation

1. In accordance with one or more embodiments, no additional hardware is required to be deployed at hotspots (at either home or roaming partner networks). This makes it easy for service providers to deploy the solution in a centralized, cost-effective, and easy to manage architecture. Unlike certain prior art systems that require a hotspot component, a solution in accordance with one or more embodiments of the invention does not require a hotspot component because it provides a client/server based solution that is agnostic to hotspot behavior and does not expect any support from the hotspot other than being a basic Wi-Fi network. The client can talk to any hotspot and the gateway can receive standards based input from hotspots. The differentiated functionality offered by the solution is achieved through the client/server communication. Certain prior art systems do not offer any of these capabilities because they lack a client component.

2. In accordance with one or more embodiments, no additional dedicated backhaul is needed at the hotspot or in roaming networks. This can be important for reducing the overall cost of deployment of the Wi-Fi service and minimizing the time to market. Unlike certain prior art systems that require a dedicated connection between the hotspot and the back-end server, service delivery platforms in accordance with one or more embodiments of the invention work off the public IP network. This is because this is primarily a control path solution. Any data that is transferred between the client and server is sent via a SSL based secure link on the public IP network (with or without a VPN). RADIUS based prior art systems are also control path solutions, but they do not offer many of the capabilities described herein.

3. A solution in accordance with one or more embodiments can inherently support a roaming environment. Public Wi-Fi services currently available are predominantly based on roaming for two reasons. First, they operate in the unlicensed spectrum so the barrier to deploying a network is low and there are inherently a number of service providers offering Wi-Fi services. Second, most networks are deployed on a first-come first-served basis at premier locations. This roaming environment means that there can be few assumptions on how different networks are designed. Further there are limited standards. As a result, for a solution to work in a roaming environment it requires that there is minimal dependence on the hotspot network itself and that the service is consistent across networks. A solution in accordance with one or more embodiments of the invention places no requirements on hotspots in terms of hardware or backhaul (see 1, 2 above) and due to the client it offers a seamless experience to the user. RADIUS based prior art systems support basic roaming but no advanced features and they do not offer a seamless experience because they don't have a client component. Other prior art systems do not support roaming well because of their requirements of hotspot networks.

4. A solution in accordance with one or more embodiments of the invention can support different types of service providers, including GSM/GPRS, CDMA, Wireline, Cable, etc. The architecture is modular and does not preclude integration into any network.

Client/Server Capabilities

5. In accordance with one or more embodiments, the client-server architecture can maintain location and reachability and session availability without being in datapath. Unlike RADIUS based prior art systems, a solution in accordance with one or more embodiments of the invention can enable the gateway to maintain information about the user's session and reachability. This makes it possible to ‘push’ data to the user and also know where the user is connected from for location aware services. This is possible because the user can be tracked through the client connection. This works even when the user has a VPN connected (typically the VPN changes the users IP address and other solutions that do not use this approach can not track the user in that case).

6. In accordance with one or more embodiments, prepaid support is provided in a RADIUS based architecture. Vanilla RADIUS based prior art solutions generally do not offer prepaid capabilities because RADIUS is a client pull protocol. The Server has no way to terminate sessions. A client-server based approach in accordance with one or more embodiments of the invention allows authorization, management, monitoring, and termination of prepaid sessions.

7. In accordance with one or more embodiments, enhanced encryption for end-to-end security management is provided. To protect user identity, user credentials sent between the client and server can be encrypted.

8. In accordance with one or more embodiments, audit and fraud detection capabilities are provided. A solution in accordance with one or more embodiments of the invention can provide the ability to audit usage information provided by hotspot operator partners. By comparing the usage sent from the client with that sent by the hotspot operator, it can be possible to detect fraud.

9. Network performance visibility and SLA monitoring can be provided. It is typically not possible to get visibility into Wi-Fi network performance, especially in roaming environments. The client in accordance with one or more embodiments of the invention can collect performance metrics that can be delivered to the gateway for monitoring network performance and SLAs.

10. Customer care support can be provided. In accordance with one or more embodiments, the client can provide visibility into session and network performance, which can be used for real-time diagnostics and customer care.

11. Combination of Wi-Fi and GSM authentication can be provided. In accordance with one or more embodiments of the invention, existing GSM/GPRS environments can be leveraged to offer SIM based authentication where the Subscriber Gateway functions as a VLR.

12. Automated location management can be provided. A solution in accordance with one or more embodiments of the invention can offer a method for automated management of location data to reduce operational costs.

Gateway:

13. Multi-session management and record aggregation can be provided. A Subscriber Gateway in accordance with one or more embodiments of the invention can support complex sessions that span across a number of parameters, including location, time, volume, connections, etc. Appropriately aggregated billing records can be generated for billing.

14. Partner management capabilities can be provided. A Subscriber Gateway in accordance with one or more embodiments of the invention can provide an easy to manage interface for managing parameters associated with Wi-Fi partners and locations.

15. Wi-Fi aware billing information can be provided. A Subscriber Gateway in accordance with one or more embodiments of the invention can collect usage information and augments it with Wi-Fi specific data such as service plan and location and generates a usage record that can be used for Wi-Fi aware billing.

16. Seamless integration with service provider environments can be provided without requiring changes to OSS/BSS infrastructure. A Subscriber Gateway in accordance with one or more embodiments of the invention can integrate seamlessly into existing service provider environments without requiring any changes to their architecture.

17. High availability can be provided through clustering. A clustering approach in accordance with one or more embodiments of the invention can provide support with minimal overhead.

Client:

18. In accordance with one or more embodiments, the server connection works even with VPN turned on. The client-server connection can work even when the user is running a VPN. This can be accomplished by running the connection over HTTPS and leveraging proxy capabilities in the enterprise network.

19. Automated service discovery can be provided. The client can automatically detect the service in accordance with one or more embodiments of the invention.

20. In accordance with one or more embodiments of the invention, a mechanism can be provided for automated connection to any HTTP based authentication through a signature based approach, without requiring re-compilation of software.

21. In accordance with one or more embodiments, the client can enable display of location specific information for branding or local services. This can be accomplished by location determination and display of appropriate data.

22. Automated log-off is possible even when a VPN is running. Once a VPN is started, it may not be easily possible for the client to disconnect a session. The client-server connection in accordance with one or more embodiments of the invention can provide a unique way to enable this disconnect.

Subscriber Gateway

The Subscriber Gateway allows retail service providers to offer Wi-Fi services to their subscribers by working with a broad range of evolving Wi-Fi networks and partners in a secure and cost effective way. The Subscriber Gateway works in conjunction with the Service Manager to provide a broad range of service capabilities.

Design Challenges

The Wi-Fi Service Delivery Platform in accordance with one or more embodiments of the invention can address several significant challenges in deploying public Wi-Fi services. These can include:

(1) Roaming across heterogeneous Wi-Fi networks and partners, including managing heterogeneous roaming partners, locations, and working across heterogeneous network architectures.

(2) Supporting end-to-end security and trust, including secure end-user authentication even in roaming networks, prevention of man-in-middle attacks, and secure communication between multiple entities in different networks.

(3) Real-time session management, including secure authentication, accounting, and end-to-end session state and user presence management in roaming networks, including interoperability with VPNs.

(4) Turnkey deployment in service provider environments, while leveraging existing infrastructure for provisioning, billing, and services.

The Subscriber Gateway architecture in accordance with one or more embodiments is designed for a turnkey deployment in a service provider network with key benefits that can include:

(1) No additional hardware is required to be deployed either at hotspots or in roaming partner networks. This specifically makes it easy for service providers to deploy the solution in a centralized, cost-effective, and easy to manage architecture.

(2) No additional dedicated backhaul is required at the hotspot or in roaming networks. This can be important for reducing the overall cost of deployment of the Wi-Fi service and minimizing the time to market.

Subscriber Gateway: Capability Details

Briefly, the Subscriber Gateway in accordance with one or more embodiments of the invention can offer functionality around four key areas:

(1) Partner, Location, and Client Management: Partner and location management address management of logistics associated with the Wi-Fi service, including roaming partner setup, Wi-Fi footprint and location management. Client management focuses on software distribution and update.

(2) Real-time Session Management: Session management capabilities include managing real-time Wi-Fi sessions, including authentication, managing presence and reachability, and controlling prepaid sessions. Session Management can be important for maintaining reachability information for the users, thus laying the foundation for delivery of advanced services. It can also allow real-time session diagnostics and customer care via Wi-Fi network performance monitoring.

(3) Usage Delivery, Reporting, and Auditing: This functionality enables delivery of usage information to BSS infrastructure for end-user billing and also allows mediation of complex sessions, generation of reports, generation of audit information, and fraud monitoring.

(4) Message Delivery Infrastructure: This set of capabilities forms the underlying platform for delivery of advanced services. Core capabilities include service plan enforcement, session termination, and message delivery.

Each of these capabilities is described in further detail below.

Partner, Location. and Client Management

Partner Management:

In order to support a large Wi-Fi footprint, service providers will generally enter into a number of Wi-Fi partnerships. Manual management of information related to these partnerships could easily become logistically burdensome. The Subscriber Gateway, in conjunction with capabilities in the Service Manager, enables service providers to manage and in some cases to automate time-consuming and potentially error-prone aspects of Wi-Fi partnership management. Partner management includes managing partner information such as names and identifiers for partners, proxy servers, physical network locations, network access controllers and access points, in addition to configuration information such as shared secrets used to establish secure proxy communication tunnels. This information can be captured and stored in a hierarchical manner by the Subscriber Gateway. An authorized employee can enter information through an intuitive, HTML-based GUI—or a file of information can be uploaded and imported.

Location Management:

A potentially difficult information to capture and manage is the database of home and partner network locations. This database is preferably maintained accurately as it is used to create the hotspot location directory that end users can search through the deployed client software. The Subscriber Gateway and Service Manager client can incorporate a mechanism for location auto-discovery whereby the Subscriber Gateway location database is populated with new locations whenever a Service Manager user successfully logs in at the location—regardless of whether the Subscriber Gateway has been pre-configured to be aware of the location. The location information is then distributed to other Service Manager users through the automated directory update mechanism described below. This mechanism creates a self-maintaining location database—minimizing maintenance and increasing accuracy—and provides a simple mechanism for partners to inform users of new locations.

Updates to the location directory can be created automatically by the Subscriber Gateway from its internal location database. In addition to the name, address and other standard information typically captured and stored in a location directory, the Subscriber Gateway location database also captures certificate information for HTTP-Intercept network configurations.

Client Management:

The Subscriber Gateway can allow service providers to manage the distribution and maintenance of Service Manager client software and location directory information automatically. The Subscriber Gateway can store the most recent versions and updates to both the Service Manager software and the location directory. An embedded web server downloads this information securely over an HTIPS connection. For initial downloads, the user is directed to this web server by the service provider web site or through another link. The Service Manager is then configured to check with the Subscriber Gateway for software or location directory updates. This operation can be performed without user intervention.

Real-Time Session Management

This component in accordance with one or more embodiments enables all aspects of managing real-time user sessions and can be broken down into the following components:

Session Management:

The Subscriber Gateway can maintain real-time session state for all active user sessions. This includes the authentication state, service profile, session metrics, as well as the user's presence and location. The Session Manager also correlates the RADIUS messages with messages received from the Service Manager (called CLIP).

The Subscriber Gateway can also manage complex “multi-sessions”. These multi-sessions are generated as a result of the common service plans used by various service providers. For instance, a service plan may allow unlimited logins from a single location over certain duration. In this case, multiple sessions may be created, one every time the user logs in. However, there is only one ‘billable’ session for all the sessions within this duration. The Subscriber Gateway has the ability to define, authorize, and enforce such service plans.

Client Communication:

The client communication module within the Subscriber Gateway can maintain a real-time secure connection between the Subscriber Gateway and every active Service Manager session. This connection is over a secure SSL-based link. The messages exchanged over this connection include software and configuration updates, prepaid control messages, etc. This channel is called herein CLIP. The Service Manager can use CLIP to send performance and other session information to the Subscriber Gateway as well as for automated software update and location directory update.

Wi-Fi Enhanced Authentication:

The Subscriber Gateway can support a range of authentication methods, including 802.1x (PEAP, MD5, MS-CHAP) and HTTP intercept. The Subscriber Gateway can have an LDAP interface that is used to communicate with an external subscriber database for retrieving subscriber information for authentication and authorization.

The Subscriber Gateway can also support SIM-based authentication using EAP SIM and provides an interface to the HLR over GSM MAP.

Through a combination of the Subscriber Gateway and the Service Manager, the solution delivers enhanced secure authentication over existing Wi-Fi infrastructure, where user credentials sent between the Service Manager and the Subscriber Gateway are encrypted. This provides confidentiality of a service provider's users, even when roaming in partner networks.

Prepaid Session Management:

Through its client/server architecture, the Service Delivery Platform can authenticate, monitor, and manage prepaid sessions. The prepaid solution can support a variety of service plans, including session, volume, duration, and location parameters. The Subscriber Gateway can use the CLIP connection to monitor prepaid session activity, warn the user on low balances, offer an ability to top up accounts, and also support session disconnection. This ability is unique to the architecture and is supported even in roaming networks. Alternative prepaid solutions generally require all bearer traffic to go through a centralized node, which is not only expensive due to bandwidth costs, but more importantly does not work in roaming networks where the service provider has no control over the traffic. Also, pure RADIUS based solutions can not support these generic prepay plans due to its client initiated paradigm. The prepaid solution in accordance with one or more embodiments of the invention supports the basic infrastructure to manage sessions and builds stubs to interface to external prepaid systems—actual integration with a specific prepaid system requires further integration.

Wi-Fi Enhanced Accounting:

The Subscriber Gateway can support real-time, reliable collection of Wi-Fi usage information. It also augments the usage records with location information, repackages the records to WAN-specific formats and delivers records reliably to mediation systems. Usage information obtained through RADIUS is augmented with venue-specific location information accessed from the Subscriber Gateway's internal hotspot location database. Data records across multiple sessions are preprocessed prior to delivery to downstream mediation systems—allowing the service provider to offer creative service plans based on location, duration, or sessions. The Subscriber Gateway processes the usage records and generates an internal Data Record (TDR).

Real-Time Session Diagnostics:

The Service Manager can collect network performance and diagnostics data such as NIC information, SSID, operating system, signal strength, and a range of other information from the Wi-Fi network. This data is delivered securely to the Subscriber Gateway over CLIP and is useful for real-time session diagnostics and customer service. The Subscriber Gateway provides an HTML-based interface through which collected data is accessed, as well as a number of analysis scripts which summarize and organize this data to provide insight into specific network issues. The Service Manager also collects data on ‘failed login attempts’ that is delivered to the Subscriber Gateway at the next successful authentication. This allows the Subscriber Gateway to identify locations that should be added to a service provider's existing footprint or rate and monitor hotspot operator partners.

Usage Delivery Reporting, and Auditing

This functionality enables the delivery of usage information to BSS infrastructure for end-user billing, generation of reports, auditing and fraud monitoring.

Multi-Session Record Aggregation and Mediation:

As mentioned earlier, the Subscriber Gateway can allow definition, monitoring, and enforcement of complex service plans. These service plans lead to the creation of multiple individual session records, which actually correspond to a single ‘billable’ entity. The Subscriber Gateway allows the aggregation and mediation of these records for delivery to downstream mediation and billing systems.

Usage Delivery:

The Subscriber Gateway allows a service provider to leverage its existing billing and mediation infrastructure as well as settlement systems. The Subscriber Gateway converts the TDR format records to specific formats that may be needed to interface with the billing system. Specific protocols supported include TAP3 and GPRS compatible G-CDRs. Other customer-specific formats can also be generated by mapping the TDR to a specific format.

In addition, the Subscriber Gateway provides an external ODBC interface that allows an external system to retrieve data from the Subscriber Gateway.

Reporting:

The Subscriber Gateway supports real-time reporting of usage, based on subscribers, partners, locations, and time; reports can be viewed graphically as well as delivered via FTP to other systems. The ODBC interface on the Subscriber Gateway can be used by external tools such as MS Excel to generate additional reports.

SLA Auditing:

The Subscriber Gateway in accordance with one or more embodiments provides support for auditing roaming partners. The diagnostics data collected by the Subscriber Gateway can be used by network operations personnel to analyze Wi-Fi partner network performance. This is especially important in cases where the service provider may not have direct visibility into Wi-Fi networks operated by partners. As described above, data is collected automatically and analyzed by the Subscriber Gateway. The data provides insight into specific networks that may have a high number of lost connections, poor signal strength, low bit rates, failed login attempts, etc. It also provides marketing insights on usage and utilization levels at particular venues.

Usage Auditing:

The Subscriber Gateway can also provide a usage audit capability. If a trust relationship with a Wi-Fi network operator has not been established, the mobile operator may want to ‘audit’ the partner to ensure that accurate usage data is being reported for the mobile operator's customers. The Service Manager can be configured in this case to capture usage statistics (e.g. time, volume) and deliver the data to the Subscriber Gateway. These audit records are cross-referenced against accounting information delivered through the RADIUS interface and discrepancies outside a pre-defined tolerance range are highlighted for investigation. This usage audit capability can also be used for fraud monitoring purposes.

Message Delivery Infrastructure

The message delivery infrastructure provides a set of service-aware capabilities and core functions that provide a foundation for the delivery of advanced services to WLAN network users.

Service Aware Authorization:

Service-aware authorization involves the ability to authorize access to specific services based on customer subscription information (time- or location-based service plan) or authentication method (e.g. provide access to WAN services only if SIM authentication is used).

Message Delivery:

The Subscriber Gateway can provide an infrastructure for the delivery of messages from the service provider network to the end user terminal on a home or partner network. The combination of the Subscriber Gateway and the Service Manager enables this delivery even when the user may be roaming into a partner network or may have a VPN connection established. Typical messages delivered are location or partner aware messages, or service provider generated messages. This can also include delivery of SMS and MMS messages.

Subscriber Gateway: Deployment

GSM/GPRS Network Deployment

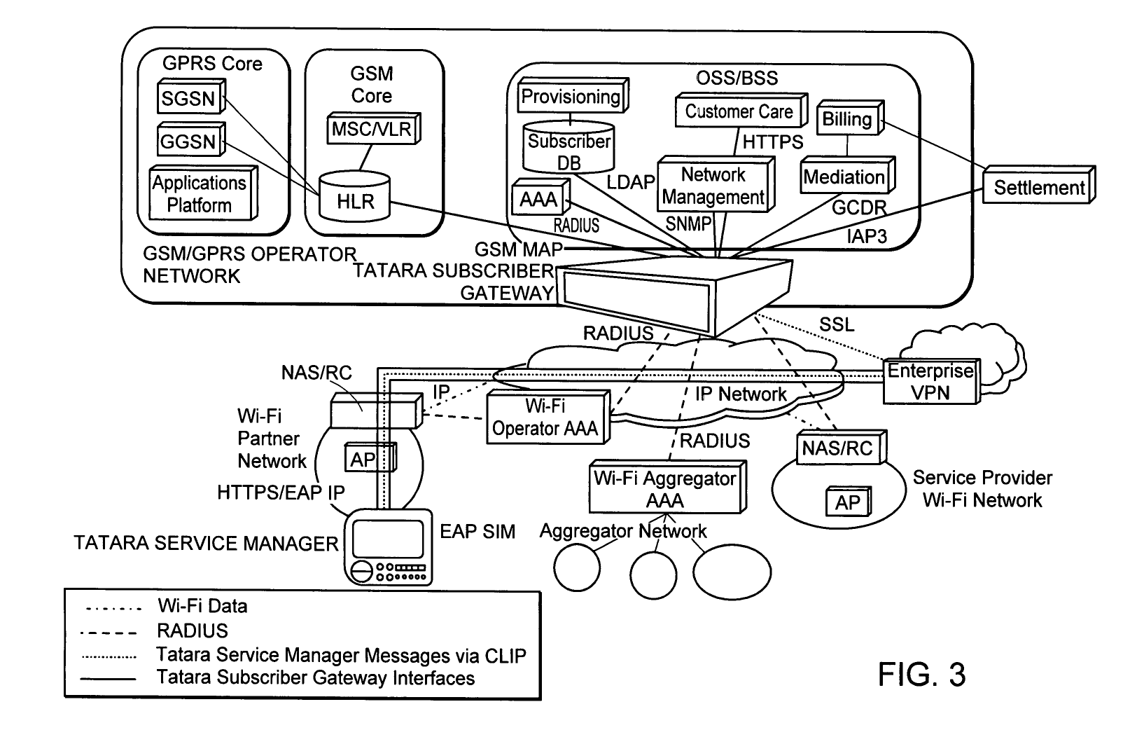

FIG. 3 illustrates a typical deployment of the Subscriber Gateway in GSM/GPRS networks in accordance with one or more embodiments.

As shown in the figure, the Subscriber Gateway can be deployed in the GSM/GPRS service provider network. The Subscriber Gateway interfaces with components in the Wi-Fi network as well as with components in the service provider core network to provide the converged Wi-Fi service offering.

GSM/GPRS core network interfaces: The Subscriber Gateway can be deployed in either an integrated or in an overlay configuration and interfaces with a number of core network and OSS/BSS components. The overall architecture supports the 3GPP Release 6 planned Wi-Fi integration architecture.

Integrated architecture: In the case of an integrated configuration, the Subscriber Gateway can interface with the existing AAA server in the GPRS core. The Subscriber Gateway proxies RADIUS messages to the AAA server, which in turn interfaces with the backend billing and provisioning systems. The Subscriber Gateway also interfaces with the HLR via GSM MAP messages. Other interfaces can include settlement (TAP3), customer support (via HTTP access), and management (via HTTP or SNMP).

Overlay architecture: In the case of an overlay configuration, the Subscriber Gateway can provide generally all the elements of the Wi-Fi service, including AAA and billing interfaces. For billing interfaces, it can generate records in GPRS G-CDR or TAP3 format. As in the integrated approach, the Subscriber Gateway can also interface with the HLR for SIM authentication. Other interfaces can include settlement (TAP3), customer support (via HTTP access), and management (via HTTP or SNMP).

Wi-Fi network interfaces: The Subscriber Gateway can interface with the Wi-Fi network over an IP interface. As mentioned earlier, the Subscriber Gateway is a control path product and does not require dedicated backhaul from the Wi-Fi network to the Subscriber Gateway. It also does not require any additional equipment to be deployed at the hotspot. The Subscriber Gateway can support a number of different Wi-Fi hotspot configurations:

Service provider deployed hotspots: In the case of service provider owned Wi-Fi network, the Subscriber Gateway can function as the RADIUS server or proxy or it can interface with an existing RADIUS proxy in the Wi-Fi network.

Roaming partner hotspots: In case of a partner Wi-Fi network, the Subscriber Gateway can interface with the RADIUS proxy in their networks.

Aggregator networks: In the case of Wi-Fi aggregators, the Subscriber Gateway can interface with RADIUS proxy in the aggregator network.

Service Manager interface: The Subscriber Gateway can interface with the Service Manager over a secure SSL-based protocol (CLIP). This communication provides a number of advanced capabilities such as enhanced secure authentication, usage data audit, and prepay session control.

CDMA/1XRTT Network Deployment

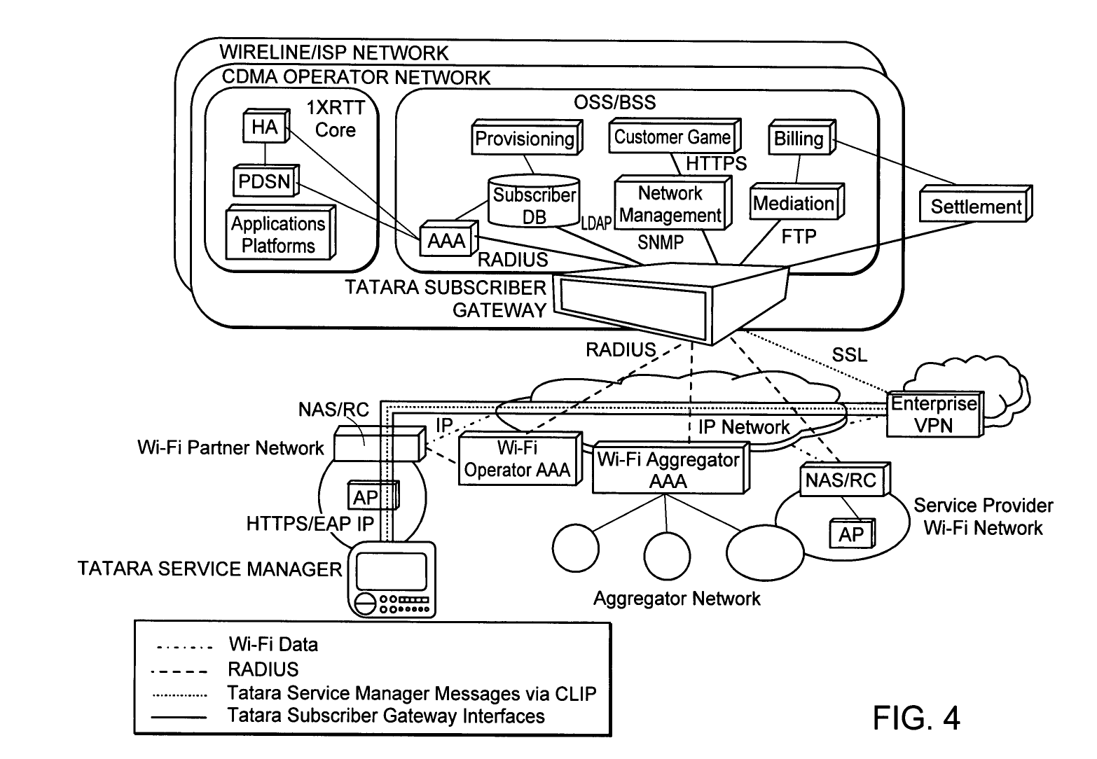

FIG. 4 shows the deployment of the Subscriber Gateway in a CDMA/1xRTT in accordance with one or more embodiments.

CDMA/1XRTT core network interfaces: The Subscriber Gateway can be deployed in either an integrated or in an overlay configuration and interface with a number of core network and OSS/BSS components.

Integrated architecture: In the case of an integrated mode, the Subscriber Gateway can interface with the existing AAA server in the 1XRTT core. The Subscriber Gateway proxies RADIUS messages to the AAA server, which in turn interfaces with the backend billing and provisioning systems. Other interfaces include settlement, customer support (via HTTP access), and management (via HTTP or SNMP). This is the approach considered by 3GPP2.

Overlay architecture: In the case of an overlay configuration, the Subscriber Gateway can provide generally all the elements of the Wi-Fi service, including AAA and billing interfaces. Other interfaces can include settlement, customer support (via HTTP access), and management (via HTTP or SNMP).

The Wi-Fi network interfaces and Service Manager interfaces are similar to the GSM/GPRS deployment, as described earlier.

Subscriber Gateway: Underlying Platform

The Subscriber Gateway is preferably a carrier-class gateway running an embedded, hardened, real-time operating system based on the Linux Debian kernel. In addition, the Subscriber Gateway can be deployed in a clustered architecture that provides reliability as well as load balancing.

Clustering is generally driven by two requirements: (1) high availability service, providing 99.999% reliability, without loss of usage data for billing purposes or loss of service experience by end users; and (2) performance improvement through scaling.

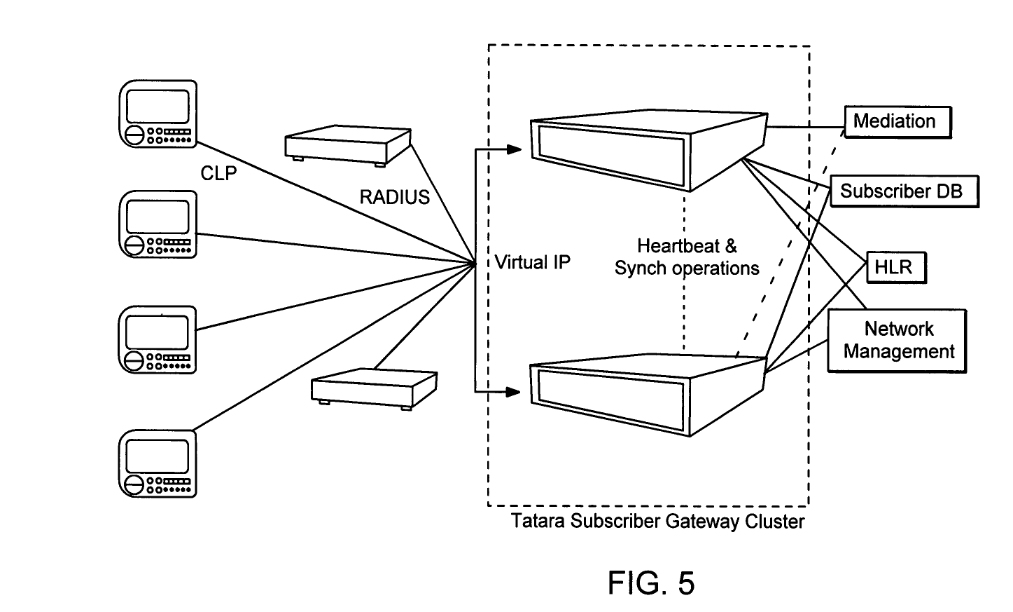

An example of an overall clustered solution is illustrated in FIG. 5. As shown, the Subscriber Gateway cluster is deployed in the service provider network. The cluster is addressed by a single virtual IP address. The IP address can be owned by the node that is the cluster ‘master’ (typically the node with the lower ID). RADIUS clients/proxies communicate with the virtual IP address. This request is received by the cluster master, which assigns the transaction to the appropriate node in the cluster. Similarly, the clients communicate with the cluster master, which assigns the request to the appropriate node. On the back end, each Subscriber Gateway communicates with the subscriber database or HLR for authentication. Mediation systems retrieve data from one of the nodes in the cluster, since usage information is replicated on both nodes. The nodes within the cluster exchange heartbeat messages for checking the health of the cluster.

This solution, in accordance with one or more embodiments of the invention, meets the two requirements required of a clustered solution. First, even if one node were to go down, there is no loss of data or service interruption. All usage data is replicated on each cluster—as a result there is no loss of data for billing purposes. Further, there is no bearer path traffic through the Subscriber Gateway, so there is no loss of service from the user's perspective. Further, enhanced services offered to end users through the client-server connection will continue to be delivered due to the cluster.

The Subscriber Gateway device can be configured and managed through any of several mechanisms. First, a robust, secure, web-based management interface enables full configuration and device management from any standard web browser. Second, a command line interface (CLI) can provide full configuration and management capabilities and allows for easy scripting by a carrier of common command sequences. Finally, a SNMPv3 interface can allow the Subscriber Gateway to be configured remotely and managed through an external network management system. A variety of user privilege levels and security settings can be used to prevent unauthorized management system access and allow graduated user access for various functional operations.

Subscriber Gateway: System Architecture

FIG. 5 shows the software modules in a Subscriber Gateway in accordance with one or more embodiments. The modules can include:

1. RADIUS: This module implements a RADIUS interface to connect with the RADIUS clients deployed in Wi-Fi hotspots. It supports the standard RFCs, including 2865, 2866, 2869. The RADIUS module supports both server and proxy capabilities.

2. Client Interface: This module provides the external interface for client connections running the CLIP protocol. The Service Manager client sessions connect into the gateway over SSL and are managed by this module. This module also collects session records from the client in the internal CTDR format and delivers them to the CTDR collection module.

3. Session Manager: This module implements the core real-time session management capability in the system. It maintains real-time state for all the active CLIP and RADIUS sessions in the system, such as authentication state, usage, device from which the session was initiated, IP address, MAC address, as well as client reachability information. The session manager manages state for service plans that last through multiple sessions and controls prepaid sessions. The session manager also collects session usage information. Specifically, it collects usage data from RADIUS and augments it with other Wi-Fi specific information such as location and service plan. This usage information is formatted into an internal data format called the TDR and is delivered to the TDR collection module.

4. Authentication: This module supports the core authentication modules, including all the 802.1× protocols such as MD5, PEAP, MS-CHAP, and EAP SIM.

5. SS7: This module implements the SS7 interface to HLRs using GSM MAP (29.002). It supports both ANSI and ITU versions.

6. TDR/CTDR collection: This module manages the collection and storage of session usage data received from both the session manager (TDR) and the client (CTDR). It also processes multiple sessions to generate aggregated session records. This data is fed to mediation for delivery to external systems. It is also used for generating reports on usage. The audit and mediation modules also use this data.

7. Mediation: This module provides the external interface with mediation, rating and settlement platforms via FTP. Data is formatted into GCDR or TAP3 formats and can be delivered to the downstream systems. Additional support for IPDR is planned for an upcoming release.

8. Audit: This module provides further processing of usage records. It supports audit of hotspot performance as well as comparison of usage information sent from RADIUS and the client.

9. Partner: This module enables configuration of partnerships with Wi-Fi operators that provide part of the footprint to the retail service provider in roaming environments. Partner configuration includes RADIUS clients, Wi-Fi hotspot locations, and NAS and AP configuration information. This data is used to generate the location directory, which is automatically delivered to the Service Manager.

10. System Management: This forms the underlying management layer within the platform. It is based on SNMP and is used to control the underlying management of the platform. Both the Web interface and Command Line Interface (CLI) utilize the management layer for consistency and completeness.

In addition to these modules, there are other storage subsystems that store partner and service plan information within the Subscriber Gateway.

The platform itself can be implemented on a Linux kernel and have multiple Ethernet and T1/E1 network interfaces.

The underlying software architecture can be based on a fully-managed, multi-process paradigm. Each core module can be implemented as a separate process and the processes communicate via an efficient and reliable socket-based inter-process communication mechanism. These processes are referred to as ‘sub-systems.’ Each sub-system runs in its separate memory space to protect against software faults. The subsystems are designed for resiliency with the help of watchdog timers. Multi-node reliability is enabled via a clustered approach for high availability.

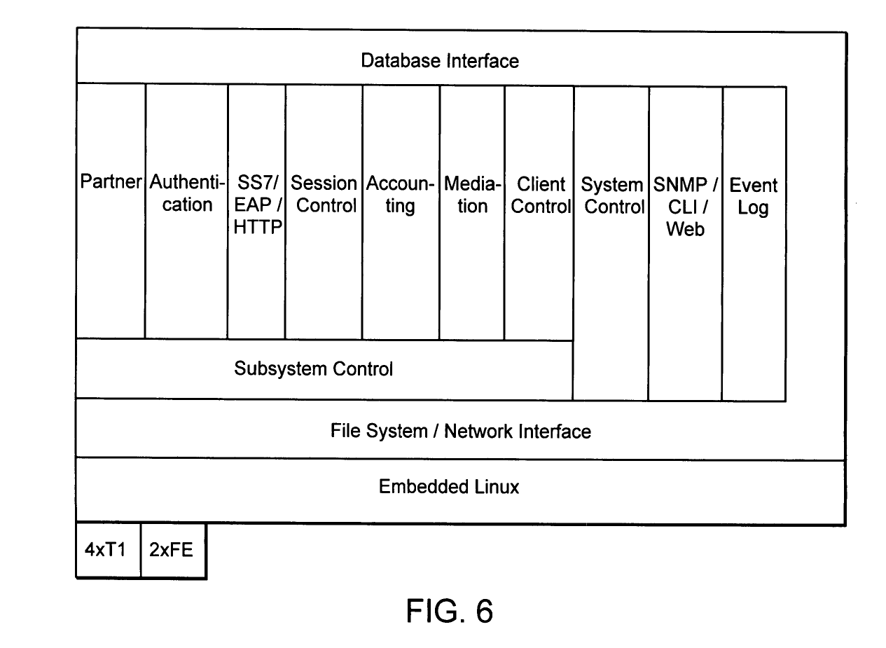

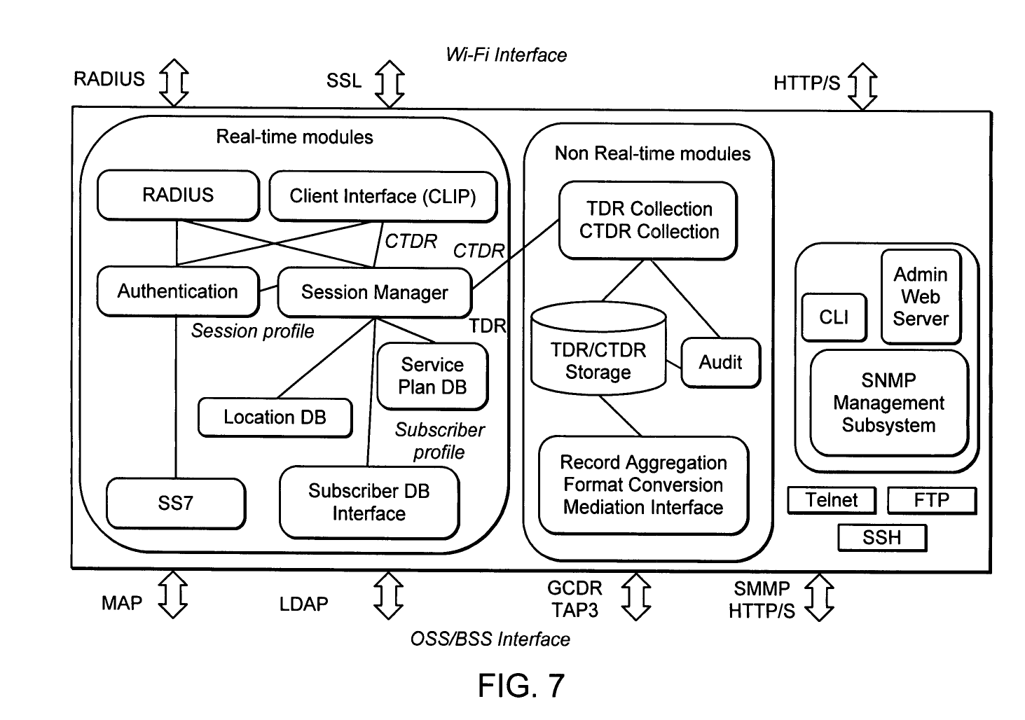

FIG. 6 illustrates components of a Subscriber Gateway in accordance with one or more embodiments. FIG. 7 shows the system architecture and internal modules of the Subscriber Gateway in accordance with one or more embodiments.

Referring to FIG. 7, RADIUS and CLIP modules provide external connectivity on the IP side. The RADIUS module interfaces with the RADIUS client or proxy in the hotspot network to receive RADIUS authentication and accounting messages. The CLIP module provides the SSL interface to terminate Service Manager-initiated CLIP sessions. The client sessions connect to the CLIP module and send additional client session records (called CTDRs) to CLIP. The Session Manager is the central module, which interfaces with the other system modules. It receives RADIUS requests from the RADIUS module and CLIP requests from the client and correlates and aggregates the information as required. When it receives a new session request, the Session Manager looks up subscriber session information by querying the subscriber database (either locally or through an external LDAP interface). The authentication module performs the authentication, invoking the SS7 module, if required, for SS7 authentication. The Session Manager keeps track of user session information, including client reachability, authentication state, etc. The Session Manager monitors progress of prepaid sessions. Further, it also maintains a ‘multi-session’ record, which is used to track service plans that comprise of multiple individual sessions. As the session progresses, the Session Manager also collects usage information. At the end of the session, the Session Manager generates a session TDR (Data Record). The TDR is sent to the TDR/CTDR collection module at the end of the session. The client optionally sends CTDRs to this module as well. Details of the TDR and CTDR are described later in this document. The Audit module correlates information from the TDR and CTDR to identify discrepancies. The Mediation module formats the TDR to a format acceptable by the external mediation systems and delivers the data to mediation systems for further processing by the service provider infrastructure.

As shown in FIG. 7, the underlying system can be managed through an NMP infrastructure, which is accessed via HTTP/S and CLI. The CLI is accessible locally or remotely via Telnet and SSH. Operations that require file transfers are supported with an embedded FTP client and server. External database access to accounting records and reports is supported via the ODBC interface.

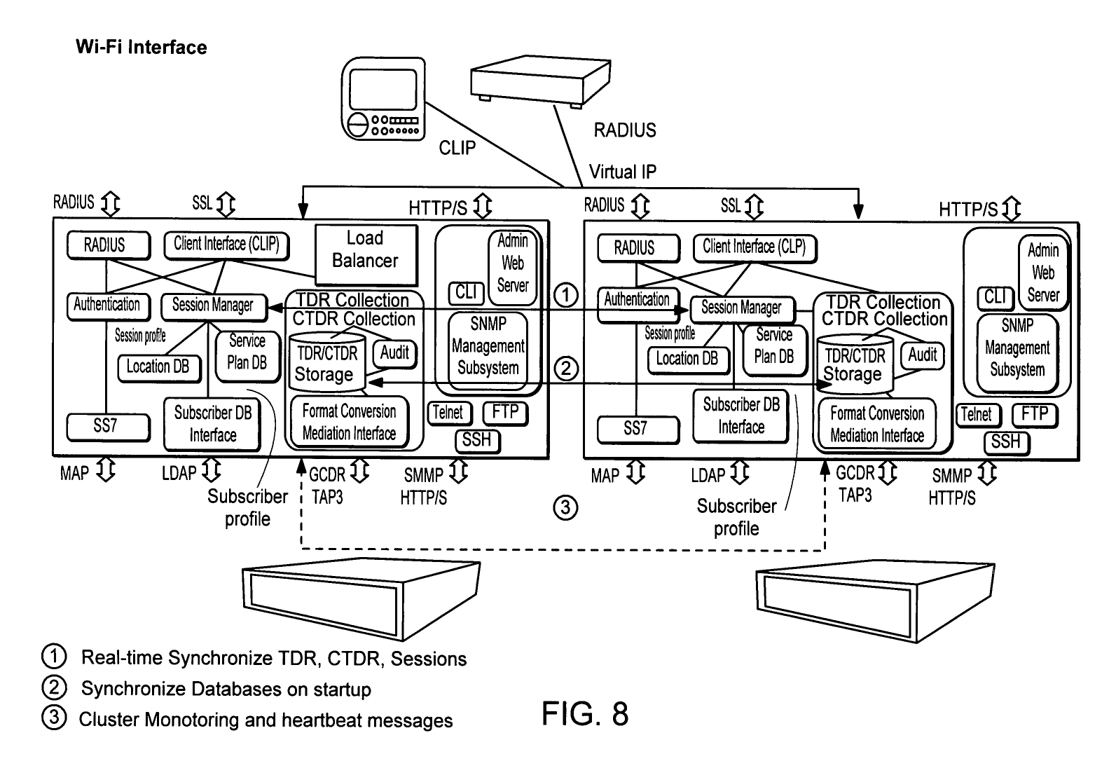

Details of the clustered solution in accordance with one or more embodiments for the Subscriber Gateway are described with reference to FIG. 8. As shown in FIG. 8, the session manager replicates information across the cluster. As a result, TDRs and CTDRs are processed by both systems. This ensures that usage is available in both nodes in the event of a failure. When a new node is added into the cluster, it first synchronizes the database before becoming active within the cluster. This ensures that the bulk of synchronization is done before it enters the cluster for better performance.

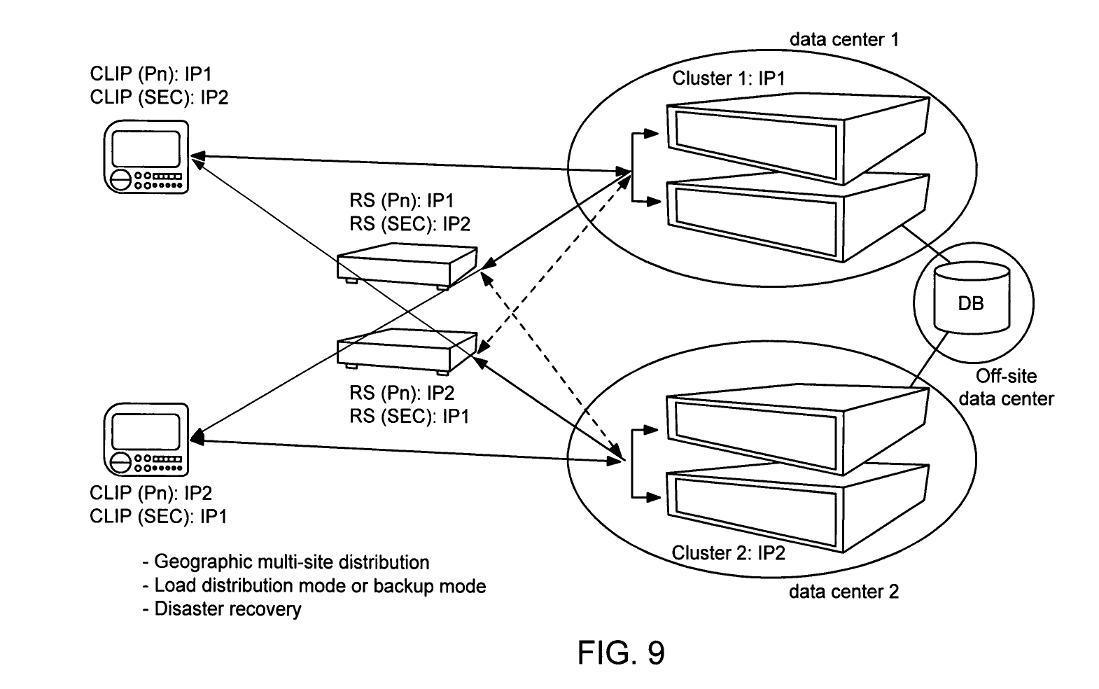

Future releases will also support multi-site clustering for increased reliability and disaster recovery. An overview of the proposed deployment is shown in FIG. 9, which shows multi-site clustering at the Subscriber Gateway.

As shown in the figure, multiple Subscriber Gateway clusters can be deployed in different sites. Each cluster has its own IP address. The RADIUS clients or proxies in the Wi-Fi network use their primary and secondary RADIUS server configurations to point to the two clusters.

The multi-site clusters can be deployed in a number of ways including the following:

(1) Load distribution mode: In this case, some RADIUS clients point to one cluster as the primary and use the second cluster for a backup, while other RADIUS clients point to the other cluster as a primary. This deployment provides geographic load sharing

(2) Back up mode: An alternative is to use one cluster as the primary cluster for all traffic and the second cluster as the backup.

The Client CLIP connections can be similarly distributed.

Note that this solution does not replicate sessions across clusters; it replicates usage data for completed sessions across the clusters. This guarantees service operation but there might be some loss of session information while the backup cluster kicks in. Frequent backup of data ensures that most billing information is captured.

Subscriber Gateway: Software Architecture

The different modules within the Subscriber Gateway are called ‘subsystems.’ Each subsystem is derived from the base Subsystem class which provides control, management, and integration services. The following summarizes the services provided by the base class.

Execution Control

Startup—a master process starts and restarts each subsystem in the event of a crash, but prevents rapid restarting

Control loop—main process loop for supporting all common subsystem services with hooks for subsystem-specific functions

Resource Limits—Memory, CPU, and Stack limits prevent single process from starving the rest of the system

Signal Handlers—Handlers for all Unix signals prevent uncaught signals from terminating subsystems

Shutdown—support for orderly shutdown including notification to management and other subsystems

Event Logging

Registration of subsystem-specific events with the central Event Log

Event filtering through management (by level, subsystem, or event ID)

Real time event logging to the central Event Log subsystem

Timers

Support for asynchronous, one-shot or repeatable timers

Granularity down to microseconds

InterProcess Communications (IPC)

Support for message and C++ object passing with other subsystems

Uses reliable Unix Domain Sockets

Non blocking, queued sends prevent unwanted context switching

Detection when remote subsystem goes up or down

SNMP Subagent

Maintains an IPC connection to the central SNMP Master Agent (MA)

Supports a common Subsystem MIB for monitoring the process state, memory usage, IPC status, etc.

Supports registration of subsystem-specific MIBs with the Master Agent

Cluster Membership

Subsystems can declare themselves as “cluster-aware” in the constructor

A cluster-aware subsystem receives notifications when other nodes in the cluster come up or go down

Cluster-aware subsystems require external IPC connections to pass messages to other nodes in the cluster. The subsystem base class supports internal and external reliable IPC support.

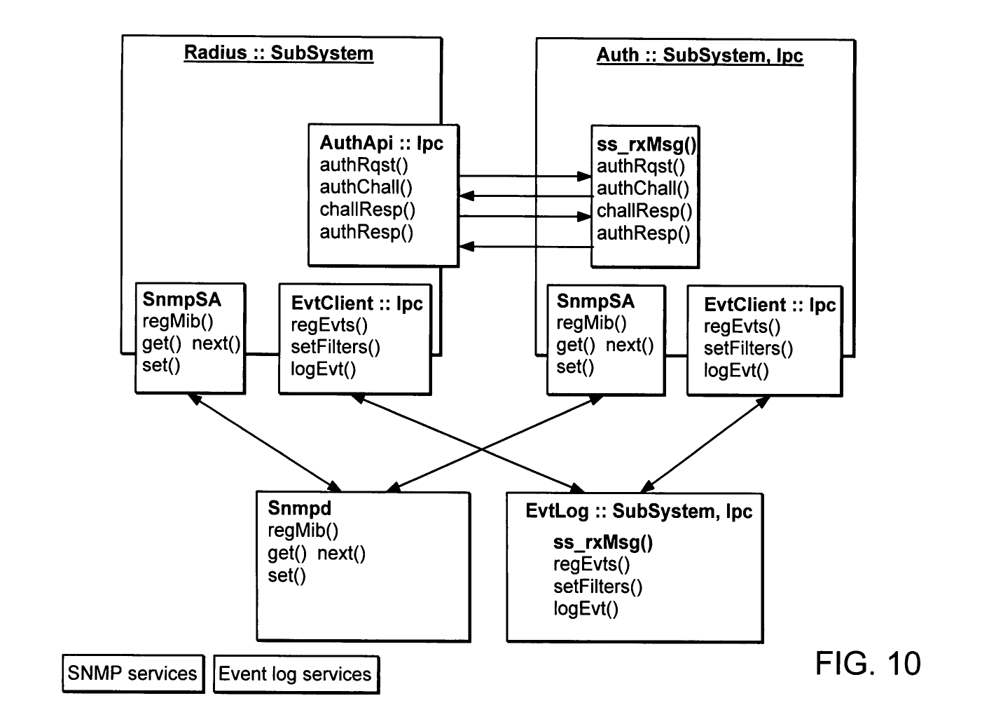

FIG. 10 shows an example of how two gateway subsystems can be integrated. Both Subsystems are derived from the base Subsystem that provides all the services described above. Both have an event client that connects to the central Event Log and an SNMP Subagent that connects to the central SNMP Master Agent for MIB support. In this example, the Authentication subsystem (Auth) provides an API to the Radius subsystem. The API methods send and receive non-blocking IPC messages to/from the Auth subsystem.

Data Formats Used in the Subscriber Gateway:

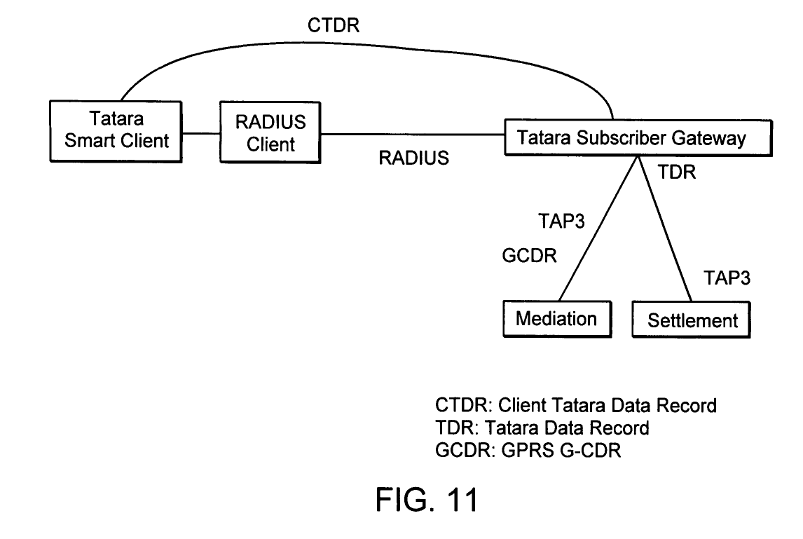

The Subscriber Gateway can use a number of data formats as shown in FIG. 11. These include:

(1) CTDR: The Service Manager collects specific session and performance information which is communicated to the Subscriber Gateway over a secure link in the form of a Client Data Record (CTDR).

(2) TDR: The Subscriber Gateway stores session information in an internal data format called the Data Record. The TDR collects usage generated by RADIUS, and augments it with Wi-Fi specific information such as location and service plans.

(3) GCDR: The Subscriber Gateway maps TDRs to GCDRs for delivery to mediation systems for client billing. Fields of the TDR are mapped to the appropriate fields in a GCDR.

(4) TAP3: The Subscriber Gateway maps TDRs to TAP3.11 records. These can be either sent to mediation systems or to settlement systems to provide audit information for partner settlement records.

Data Record Information

Table 1 below lists the attributes of the Data Record. These augment information from the RADIUS record with location and service plan information.

TABLE 1
TDR Format

| Field | Description |
|---|---|
| User Realm | Realm used to authenticate this user |
| User Id | User Id (User Name, Phone Number of IMSI) used |
| | to authenticate this user |
| Device Id | Device Id with which the User connected to the |
| | session |
| Start Time | Start time of the session |
| End Time | End time of the session |
| Gateway Id | Id of Tatara Gateway |
| Gateway Session Id | Session Id given to a session by the Tatara Gateway |
| Error Code | Error code for the session |
| User Name | User name of the subscriber |
| Phone Number | Phone number of the subscriber |
| IMSI | IMSI of the subscriber |
| Pay Plan | Pay plan of the subscriber |
| Service Plan Id | Id of the subscriber's service plan |
| Service Access Id | Access Id of the subscriber's service plan |
| Service Start Time | Start time of the subscriber's service plan |
| Service End Time | End time of the subscriber's service plan |
| Service Plan Days | Valid days of the subscriber's service plan |
| Service Location | Location categories of the subscriber's service plan |
| Categories | |
| Service Access | Access of the subscriber's service plan |
| NAS Id | Id of the Network Access Server |
| NAS Certificate Id | Id of the Network Access Server security certificate |
| NAS IP | IP Address of the Network Access Server |
| NAS Session Id | Session Id given by the Network Access Server |
| Location Partner | Location partner providing service at this location |
| Location Id | Id of this location |
| Location Name | Name of this location |
| Location Address | Location address of this location |
| Location TZ | Offset of this location from GMT |
| Location DST Flag | Was DST in effect |
| Location Category | Location category of this location |
| Auth Method | Authentication method used |
| Auth Proxy | Was this authentication proxied |
| Interims | Number of interim accounting records |
| Bytes In | Bytes transferred in during session |
| Bytes Out | Bytes transferred out during session |
| Packets In | Packets transferred in during session |
| Packets Out | Packets transferred out during session |
| Session Duration | Duration of session |
| Term Cause | Cause of the session termination |
| Client Version | Version of the client software |
| Client SN | Serial number of the client |
| Client IP | IP address of the client |

Client Data Record Information

Table 2 below lists the attributes of the client data record. This information is captured by the client and stored in the Subscriber Gateway

TABLE 2
CTDR Format

| Field | Description |
|---|---|
| User Realm | Realm used to authenticate this user |
| User Id | User Id (Name, Phone Number or IMSI) of |
| | session user |
| Device Id | Device Id (typically the MAC address) of the client |
| Start Time | Start time of the session |
| End Time | End time of the session |
| Gateway Id | ID of Tatara Gateway |
| Gateway Session Id | The Session Id given to a session by the |
| | Tatara Gateway |
| Type | CTDR Type, FULL or FAILED |
| IMSI | IMSI of session user |
| Bytes In | Bytes transferred in during session |
| Bytes Out | Bytes transferred out during session |
| SSID | Network name of the wireless network |
| NAS Certificate Id | NAS certificate Id |
| NAS Id | Location NAS Id |
| Location Id | Id of this location |
| Client Version | Version of the software running on the client |
| Client Serial | Serial number of the client |
| Link Speed | Connection speed between the client and the access |
| | point |
| Error | Connection error |
| Packets In | Packets transferred in during session |
| Packets Out | Packets transferred out during session |
| Session Duration | Duration of the current session |
| Signal Strength | Signal strength between the client and the access |
| | point |
| Link In Errors | Errors on data transfers to the client |
| Link Out Errors | Errors on data transfers from the client |
| Failed Logins | Number of failed login attempts |

Subscriber Gateway: Operation

Exemplary operation of the system is described next. The operation can be divided into three steps: (a) system setup, (b) service setup, (c) run-time operation.

System Setup

The system setup process includes starting and configuring the Subscriber Gateway. Parameters that typically are configured include the network settings (IP address, DNS, DHCP, etc.), SS7 settings (link settings, point codes, etc.) as well as security settings (certificate management). These configuration options are available from the different tabs on the Subscriber Gateway interface.

Service Setup

The service setup process includes configuring the system to deliver Wi-Fi services.

Partner Configuration: This step allows the retail service provider to configure Wi-Fi network connection settings. This includes specifying the RADIUS clients, associated shared secrets, etc. so that the hotspot partner can send RADIUS information to the Subscriber Gateway. As part of partnership setup, the partner also needs to configure its RADIUS server to proxy authentication and accounting requests to the Subscriber Gateway. For instance, if the retail service provider is ABC Wireless and if the hotspot operator is XYZ: The RADIUS client in XYZ's network is configured to proxy all requests for user@abcwireless.com to ABC Wireless' Subscriber Gateway.

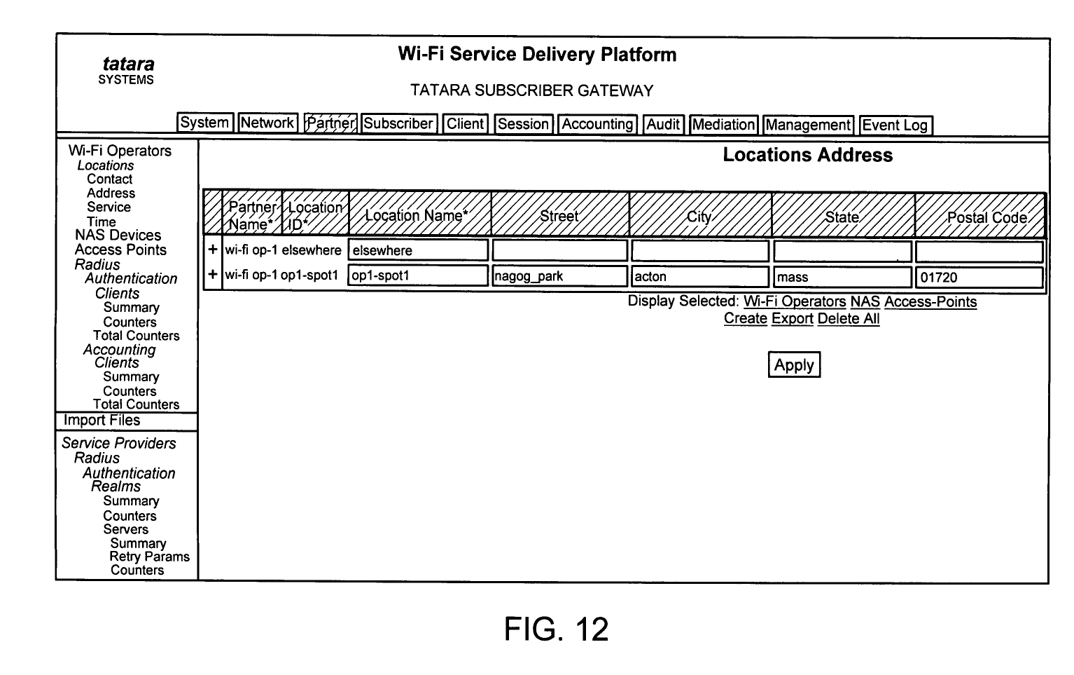

Location Configuration: The retail service provider configures Wi-Fi footprint information. This can be done by specifying the location information associated with each partner. The location information includes a list of AP's, NAS, etc. that are part of the footprint as well as address, phone number, etc. and any location-specific links that can be displayed on the client. This information is used to generate a location directory that is downloaded by the client. Note that as new partners are added or as new locations are added, the operator can configure the system to add the new information without affecting the run-time operation of the system. The Subscriber Gateway automatically generates the updated location directory that can be used for distribution to the client. A sample screen shot of the location management process is shown in FIG. 12.

Client configuration: This step allows the service provider to configure specific information for managing the Service Manager client. As with (1 and 2) above, these parameters can be changed any time during operation of the Subscriber Gateway as well without affecting the performance of the Subscriber Gateway.

a. Version, download location: The current version of the client to be downloaded and the location from which the client is to be downloaded is configured. This enables currently deployed Service Manager clients to upgrade their installed clients.

b. Configuration parameters: The retail service provider has control over a number of configuration parameters in the Service Manager. This includes Wi-Fi network preferences, blocked networks, address of the Subscriber Gateway, etc.

c. Message delivery: The Subscriber Gateway can also deliver targeted messages to users. These can be delivered on user login or broadcast to all connected users. These messages can also be configured on the Subscriber Gateway.

Mediation configuration: The mediation interface on the Subscriber Gateway delivers formatted mediation records to the downstream mediation systems in the service provider network. Typical configurations on the mediation system include setting the location of the mediation system, configuring the frequency of mediation runs, etc.

HLR Configuration: In case of SIM authentication, configure the SS7 module in the Subscriber Gateway to connect with the HLR. This requires configuration of point code etc.

Run-Time Operation

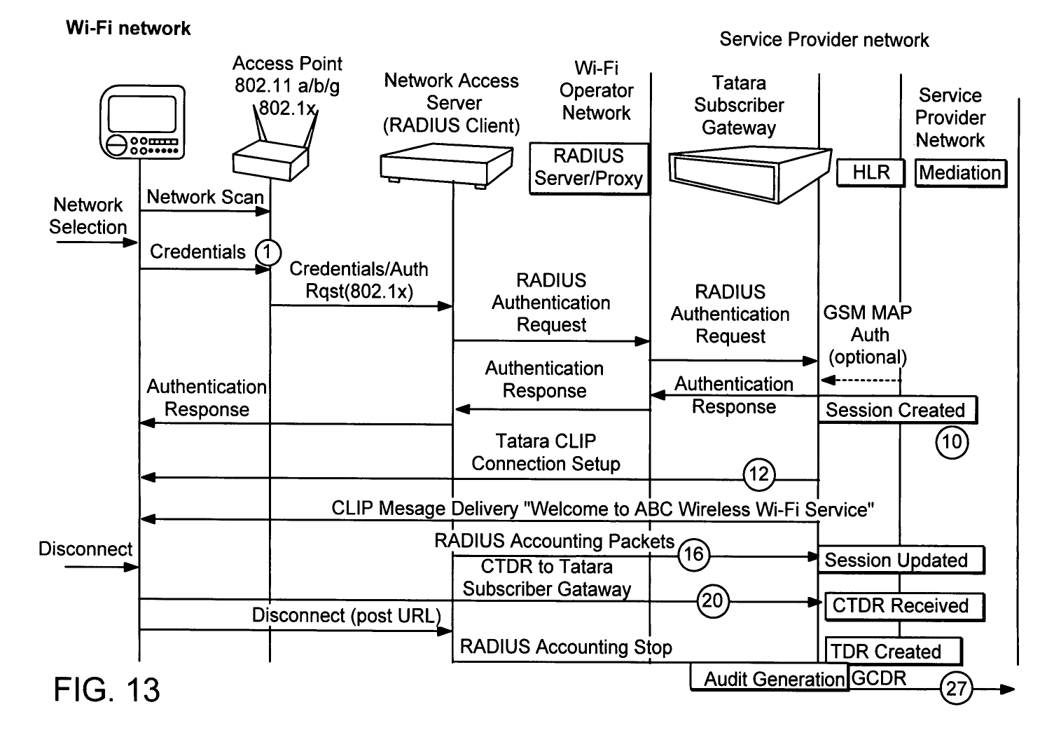

On signing up for service with the retail service provider, the subscriber downloads the Service Manager client on the terminal. The following exemplary sequence of events describes the operation of the Service Manager and Subscriber Gateway when a user running the Service Manager on the terminal enters a hotspot. It is assumed that the user has established login credentials as part of service signup (see FIG. 13 for a specific call flow).

1. User comes to a hotspot and runs the Service Manager client software. The Service Manager presents the user with the available network information. The user selects the appropriate network to connect to (or if an auto-connect profile is set up, the client sends a login request on behalf of the user).

2. The authentication information is received by the hotspot RADIUS client and forwarded (via possible intermediate proxy servers) to the Subscriber Gateway. As part of the Wi-Fi partnership setup process, the RADIUS proxy in the hotspot network is configured to forward realm-based requests to the appropriate Subscriber Gateway in the service provider network.

3. The RADIUS module in the Subscriber Gateway receives the authentication request.

4. The RADIUS module forwards the request to the authentication module. The request contains the user credentials.

5. The authentication module passes the information to the Session Manager.

6. The Session Manager uses the RADIUS NAS information and does a location lookup with the Partner Module. If provisioned, the NAS location information is copied into the session.

7. The Session Manager queries for user information from the subscriber database. Typically, the subscriber database is an external LDAP interface. The Subscriber Gateway can also support a local internal database for demonstration and test purposes.

8. The Session Manager uses user and location information to determine the applicable Service Plan for the session.

9. The Session Manager creates an active session and populates it with basic session, partner, location, subscriber, and service plan information obtained from the Subscriber database. In the case of multi-session plans, the extended session information is updated and an individual session for the session is created.

10. The Session Manager passes the subscriber information to the authentication module.

11. The authentication module authenticates the session and sends the appropriate response to the RADIUS and Session manager modules.

12. The Session Manager updates the session status.

13. The RADIUS module sends the response back to the RADIUS clients. Note that depending on the type of authentication involved, multiple RADIUS messages may be exchanged.

14. The Service Manager registers with the Subscriber Gateway via the Client Interface module.

15. The CLIP module authenticates the user (if necessary) and sends the client session information to the Session Manager.

16. The client may provide hotspot location information. If so, the Session Manager queries the Partner module for client location information and updates the session with this information.

17. The Session Manager updates the session information with additional information provided by the client.

18. At any point, if the user starts a VPN connection, the CLIP session can restart after the VPN re-establishes.

19. As the session proceeds, RADIUS collects accounting information from the RADIUS clients.

20. The accounting information is sent to the Session Manager. Typically, the accounting records are received as interim records.

21. The Session Manager updates the session status with usage information.

22. The Service Manager may submit interim requests to update software etc. These requests are received and served by the CLIP module.

23. When the session terminates, RADIUS receives a session stop message from the RADIUS client.

24. If the client does an explicit disconnect, CLIP receives notification from the client. As part of the session termination, the Service Manager sends a client session log (called CTDR for Client Data Record) to the CLIP module. (In case of a client disconnect due to timeout the CTDR is sent at the next successful connection.)

25. The CLIP module sends this CTDR to the CTDR collection module at the end of the session.

26. At session termination, the Subscriber Gateway RADIUS module communicates the stop message to the Session Manager.

27. The Session Manager updates the session information and generates a TDR (Data Record). This record is sent to the TDR collection module.

28. As part of the post-session processing, the audit module processes TDR and CTDR information. For every CTDR received, it extracts the corresponding TDR and compares the information to generate and Audit record. A mismatch in usage reported by the user client and the RADIUS client is tagged within an Audit record.

29. The usage information for all sessions is collected in an internal SQL database.

30. Usage reports based on time, location, partner, etc. are run on the internal SQL database via the Subscriber Gateway user interfaces.

31. The Mediation module runs at a programmable frequency and converts the TDRs into the appropriate format records (e.g., GPRS CDRs or TAP3 records) and delivers them to the mediation system. Aggregated XTDRs are also generated depending on the service plan.

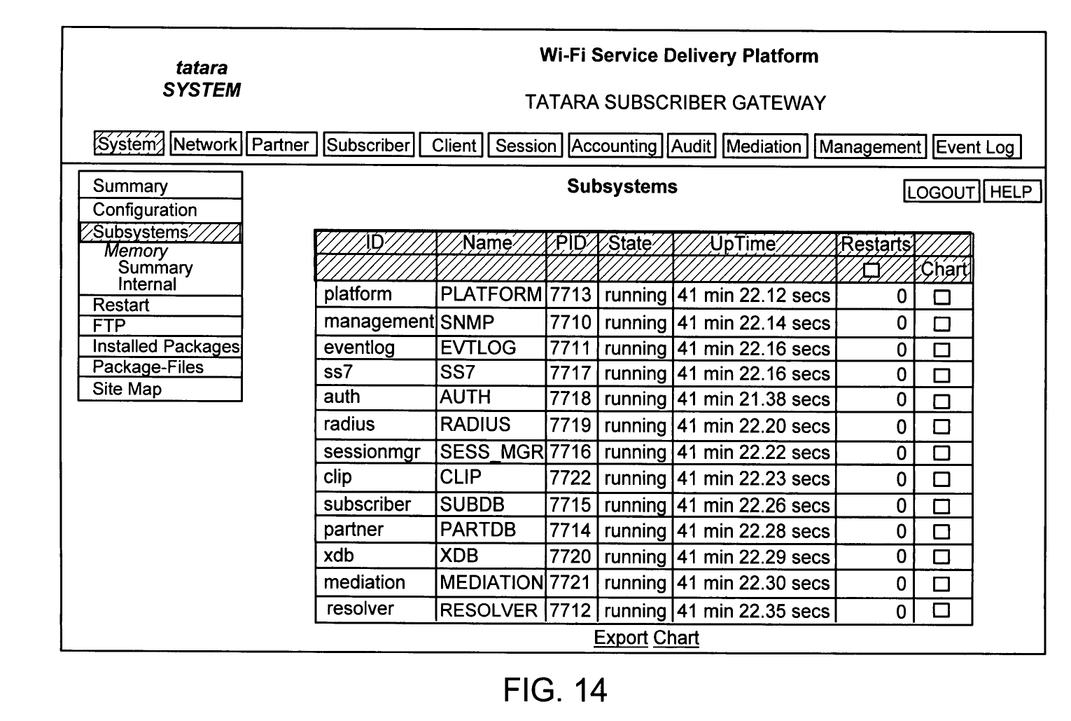

In addition to the above real-time session sequence, an administrator can use the Web or CLI interface on the Subscriber Gateway to manage the gateway at any time. A sample screen shot of the Management interface is shown in FIG. 14. FIG. 14 shows the different modules in the Subscriber Gateway that are running currently.

SIM Authentication

As mentioned above, the Subscriber Gateway can support SIM based authentication, which allows GSM/GPRS service providers to leverage their existing infrastructure for the support of Wi-Fi users. Two variants of SIM authentication are 802.1x based and non 802.1x based authentication.

In accordance with one or more embodiments of the invention, for networks that support 802.1x, SIM authentication can be accomplished through the EAP SIM protocol, where the Service Manager and the Subscriber Gateway exchange SIM authentication information over an 802.1x infrastructure. In this mode, the Subscriber Gateway emulates a VLR from the GSM network perspective. (Note that one alternative to this approach is to emulate an SGSN GPRS attach for Wi-Fi services. The VLR emulation was selected in order to allow simultaneous GPRS and Wi-Fi services.)

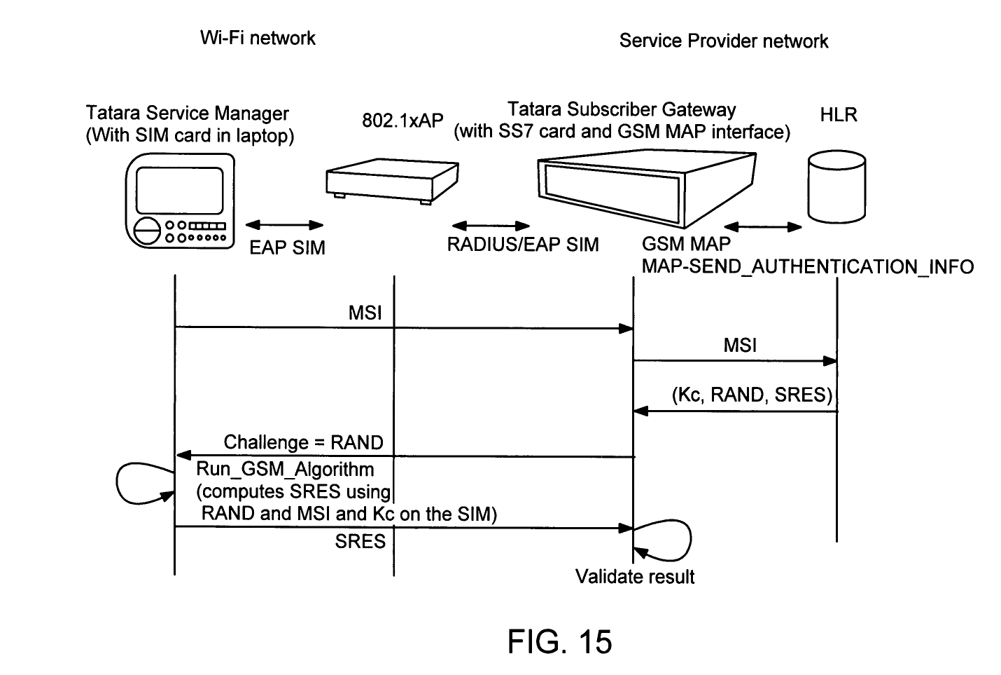

To support SIM authentication, the user's terminal typically has a SIM dongle, which could either be a USB device or a PCMCIA card reader. By way of example, to start the SIM authentication, the Service Manager queries the SIM for the IMSI and sends it to the Subscriber Gateway. The Subscriber Gateway in turn, sends a GSM MAP message MAP_SEND_AUTHENTICATION_INFO to the HLR. The HLR responds with a triplet, including a random number RAND and an expected result SRES. The Subscriber Gateway sends the RAND over to the Service Manager. The Service Manager passes the RAND value to the SIM. The SIM runs the embedded GSM algorithm (RUN_GSM_ALGORITHM) to compute the result SRES. The Service Manager returns the SRES value to the Subscriber Gateway. The Subscriber Gateway compares the expected result with the result from the client, and on a match, authenticates the user. This operation is summarized in FIG. 15.

While the above method works for networks that support 802.1x, most public hotspots today do not support 802.1x. In accordance with one or more embodiments of the invention, in order to extend the benefits of SIM authentication to such networks, a two stage authentication process is also provided that works on HTTP based authentication architectures.

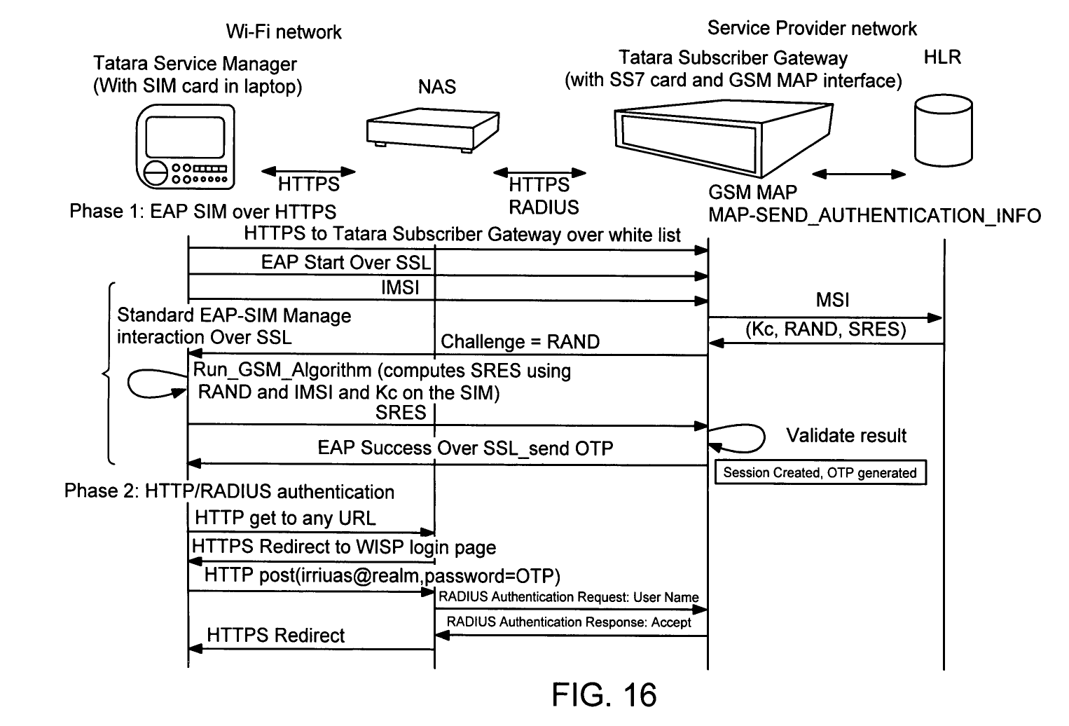

The process is summarized by way of example in FIG. 16. The authentication can be done in two stages. In the first stage, the SIM exchange is done over an SSL connection to the Subscriber Gateway. The overall messages exchanged are similar to the EAP SIM protocol with the difference that the end-to-end messaging between the Subscriber Gateway and the Service Manager uses EAP over SSL. Once the SIM based authentication succeeds, the Subscriber Gateway sends a one time password (OTP) to the Service Manager. In the second stage, the basic HTTP/RADIUS based authentication at the hotspot is leveraged with the exception that the user now sends the user name with the OTP as the password. The NAS converts this into RADIUS messages, which is sent to the Subscriber Gateway. The Subscriber Gateway authenticates the user using this OTP. If the OTP matches, the authentication succeeds.

Credential Encryption

As mentioned above, one security capability of the service delivery solution is its ability to provide end-to-end encryption of user credentials. This is especially useful when the user is in a roaming network and the user's home service provider does not wish to expose the identity of its users to roaming networks.

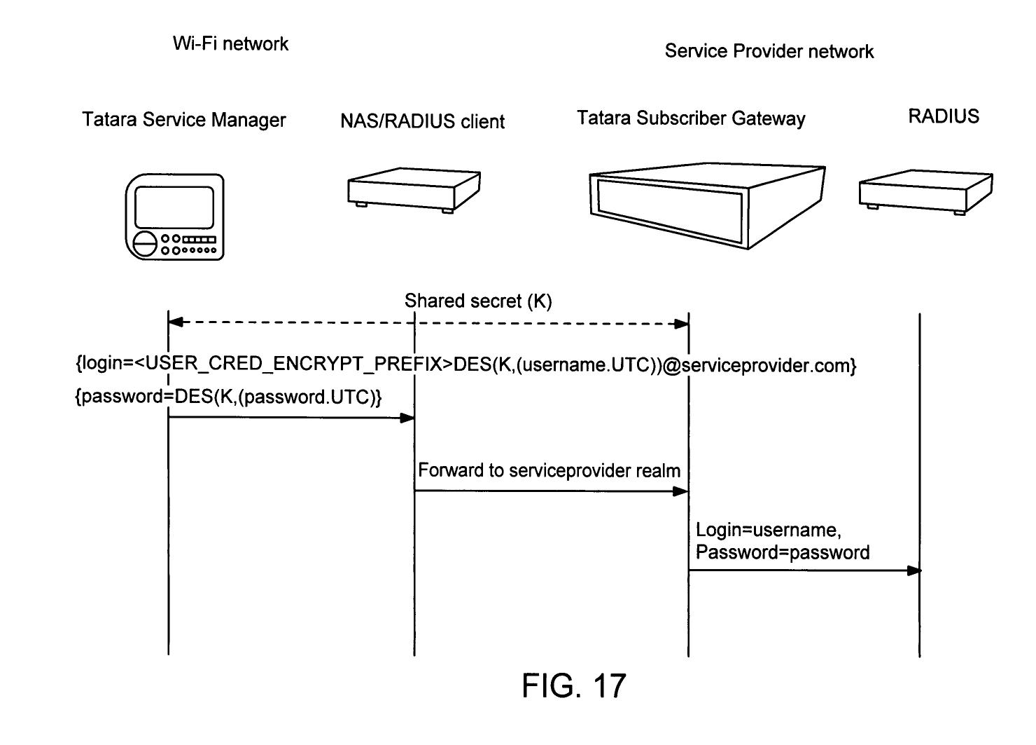

To support credential encryption, the Service Manager and the Subscriber Gateway share an encryption key. The Service Manager encrypts the user credentials (login and password) with this key using DES encryption. The realm is left unencrypted, allowing the authentication request to be appropriately proxied from the Wi-Fi network to the home service provider. This credential encryption is summarized in FIG. 17.

Two Stage Web Authentication

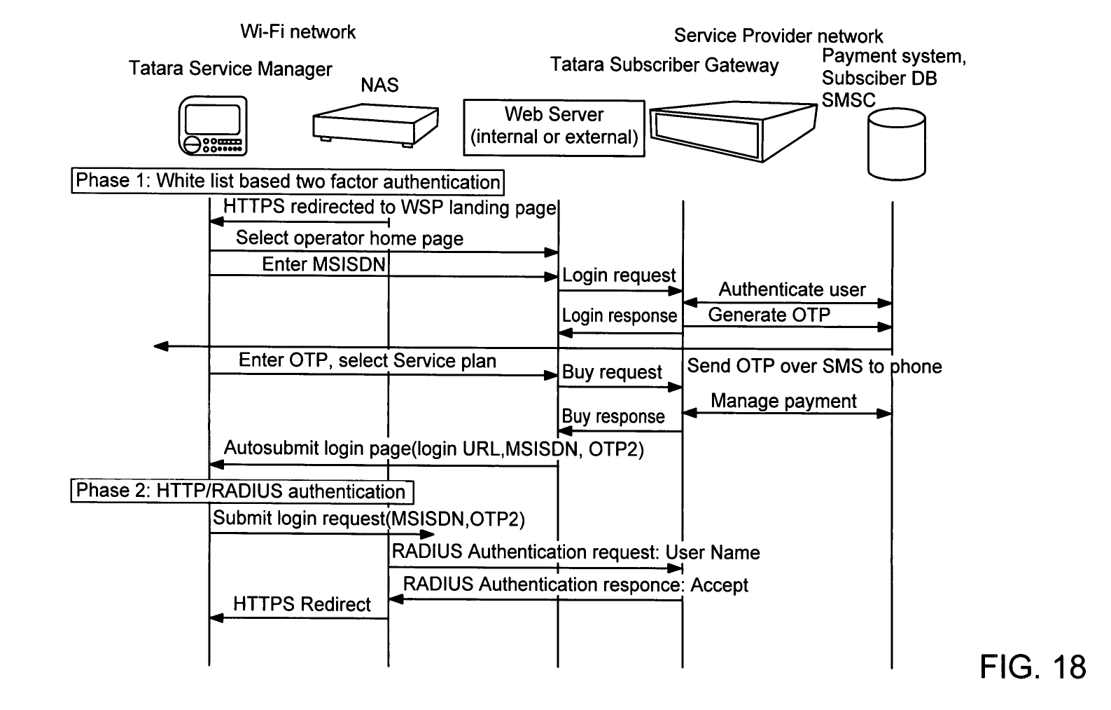

In accordance with one or more embodiments of the invention, the Subscriber Gateway can support authentication of users that login using the web interface, e.g., users that do not have client software. The challenge in this approach is to ensure that the service provider can securely authenticate the users through a centralized location, while interoperating with the hotspot architectures. A two stage approach, as summarized in FIG. 18, is described below by way of example.

In the first stage, the user is authenticated through the MSISDN (mobile subscriber ISDN) directly by the Subscriber Gateway located in the service provider network. Specifically, the user presents credentials in the form of the MSISDN to the service provider. The Subscriber Gateway validates this MSISDN and sends a one time password to the user to his cell phone. The user then provides this password to the Subscriber Gateway for authentication. This approach of using a temporary password ensures that the user's password is not sent over the network—instead the temporary one time password provides the required authentication. The physical possession of the phone is used effectively for two factor authentication. Once authenticated, the user then selects a service plan, which is authorized and billed by the Subscriber Gateway. This interchange between the user and the service provider is accomplished by the hotspot placing the service provider on a ‘white list,’ which is a restricted list of URLs a user can initially access prior to authentication.

Once the front end authentication is completed, the next step is to allow the user to get authenticated at the hotspot. This can be accomplished in the second stage. The Subscriber Gateway first sends a web page with the user credential and a second one time password embedded in it. The user submits this page to the NAS. The NAS then converts this to a RADIUS message that is sent to the Subscriber Gateway for authentication. The typical RADIUS exchange then follows, and the user is authenticated.

Prepaid Operation

This section provides further details on the operation of the prepaid capability. As mentioned earlier, the approach is to provide basic infrastructure for the support of prepaid capabilities, including service authorization, balance monitoring, balance top-up, and session disconnect. Specific integration with a prepaid system would require some customization around the APIs provided.

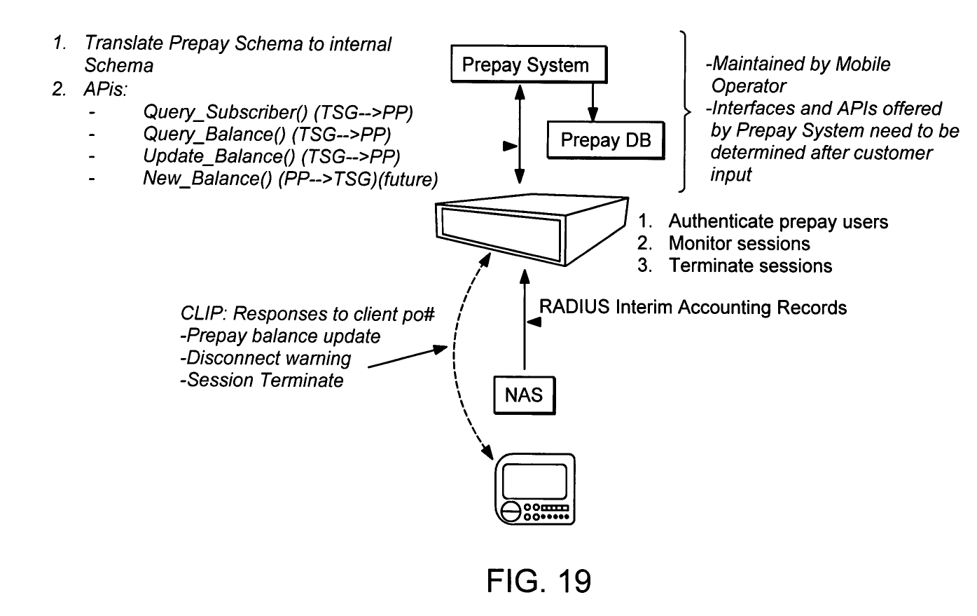

As shown in FIG. 19, the Subscriber Gateway- Service Manager communication channel is used to inform the user with prepaid balance information, warn the user when the balance runs low, direct the user to a location to top up the account, and if required, disconnect the session. This approach supports a number of types of prepay, including volume, time, sessions, etc. The alternative to this approach is to use RADIUS, which is very limited to time based prepay and that too when RADIUS clients support a session timeout attribute.

Integrating the prepaid capability into a service provider's system involves mapping of the APIs from the Subscriber Gateway to the appropriate messages offered by the service provider system.

Multi-Session Service Plan Processing

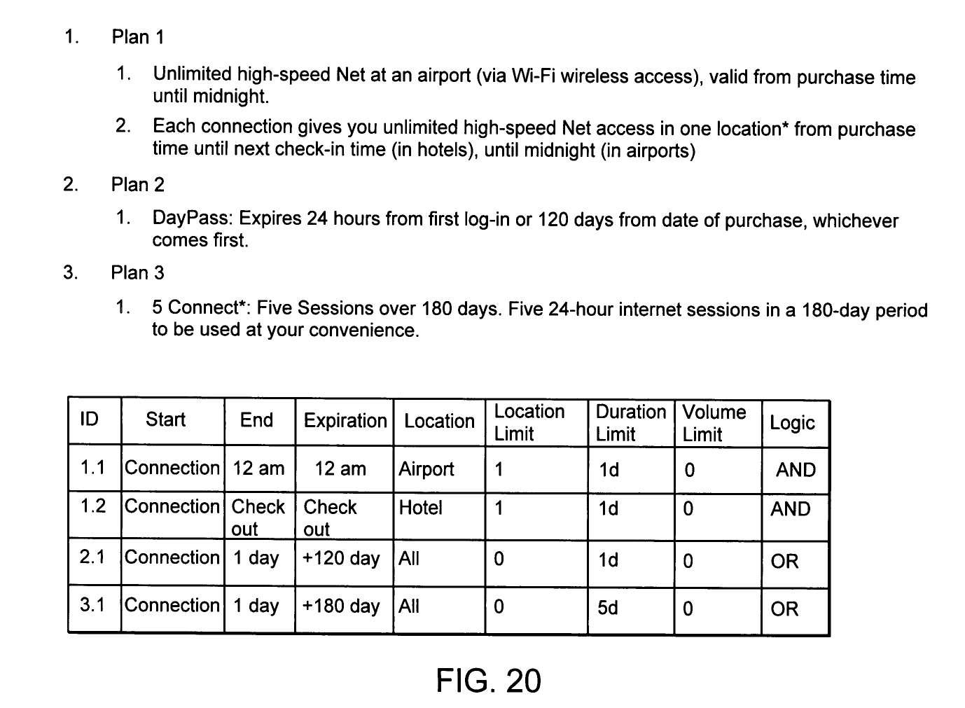

Multi-session processing capabilities are described in further detail in this section. FIG. 20 shows some typical service plans offered by some sample service providers. These service plans can be captured by a number of parameters, such as start time, end time, locations allowed, volume allowed, duration allowed, the type of location to connect from, etc. Further, logic rules can be used to specify additional combinations, as shown in the figure.

The challenge in supporting complex service plans such as these is to have the ability to enforce a specific plan as part of the authentication and billing process.

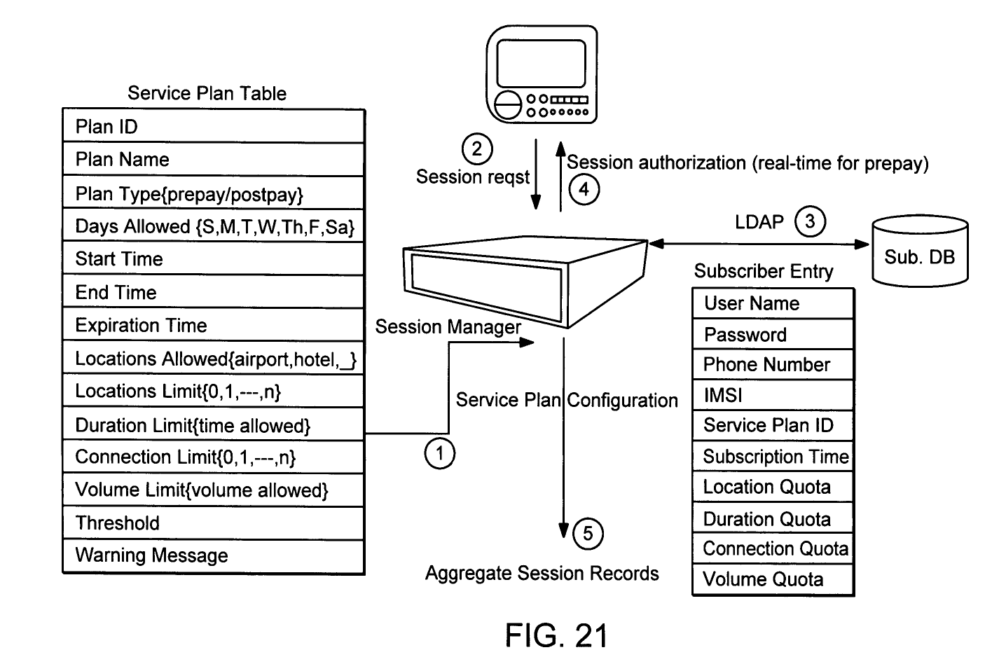

As shown in FIG. 21, the operation sequence is as follows:

1. Service plans are defined in the Subscriber Gateway using the different parameters (Users are provisioned in the subscriber database outside of the operation of the Subscriber Gateway and the subscriber information in the subscriber database identifies the service plan associated with that user's service.)

2. The subscriber connects using the Service Manager and user credentials are available at the Subscriber Gateway

3. The Subscriber Gateway looks up the user's profile in the subscriber database to determine the type of service plan. The plan may be prepaid or postpaid and is characterized by the different parameters discussed earlier.

4. The session manager then authorizes the user for service, depending on the balance and type of service. As the session progresses, the session manager monitors the session.

5. At the end of the session, the session manager generates a usage record.

Depending on whether the session is part of an extended session or not, multiple session records are then aggregated to generate a single billable record.

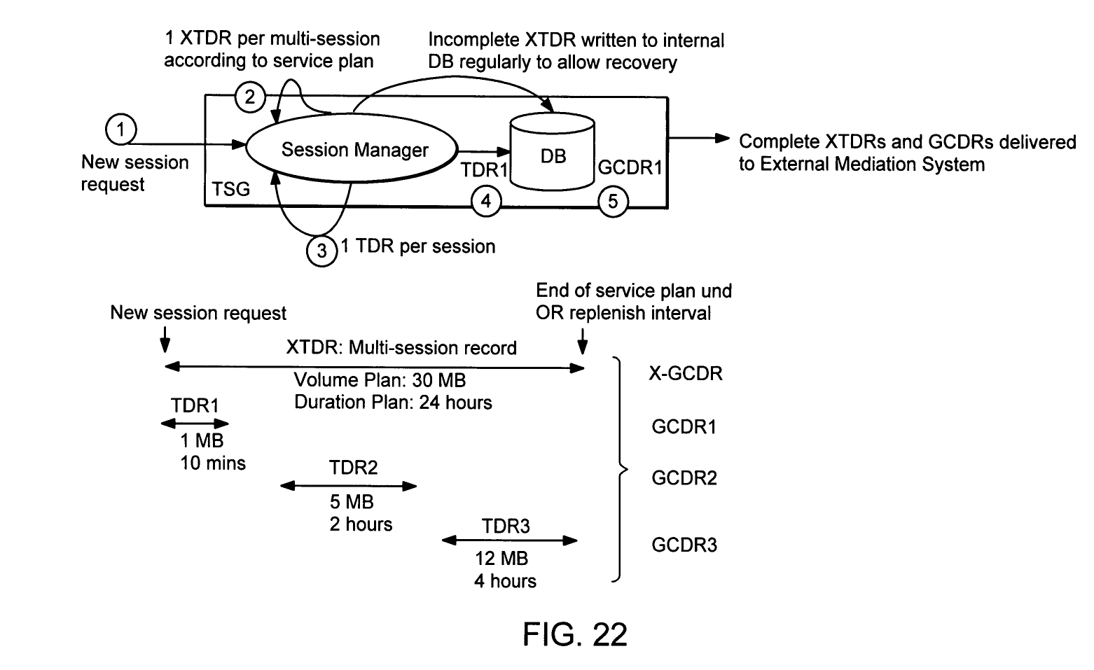

As shown in FIG. 22, the session manager maintains a ‘multi-session’ record (defined as an XTDR) that lasts for the duration of a service plan. One XTDR may contain individual session records (TDRs and CTDRs). At the end of each individual session, the TDRs and CTDRs are written out to the internal database. The XTDR is also periodically written out to the database, but is marked as incomplete until the session duration expires. For instance, for a duration based plan, the XTDR expires when the overall time in the plan expires (unless the session is replenished, in which case the XTDR extends further), whereas individual sessions may correspond to smaller units of usage. Similarly, for a volume based plan, the XTDR ends when all the allowed data in that plan is used up, while individual sessions may terminate for each session. Once the multi-session is terminated, the aggregated record (which contains pointers to individual records) is written out and is available for mediation and billing.

Note that some of the record aggregation described above can be handled by some mediation systems, but it is desired to provide a flexible and generic infrastructure that can feed data to such systems as well. The authorization of sessions still requires management of the XTDR within the session manager.

Subscriber Gateway: Synergy with Standards

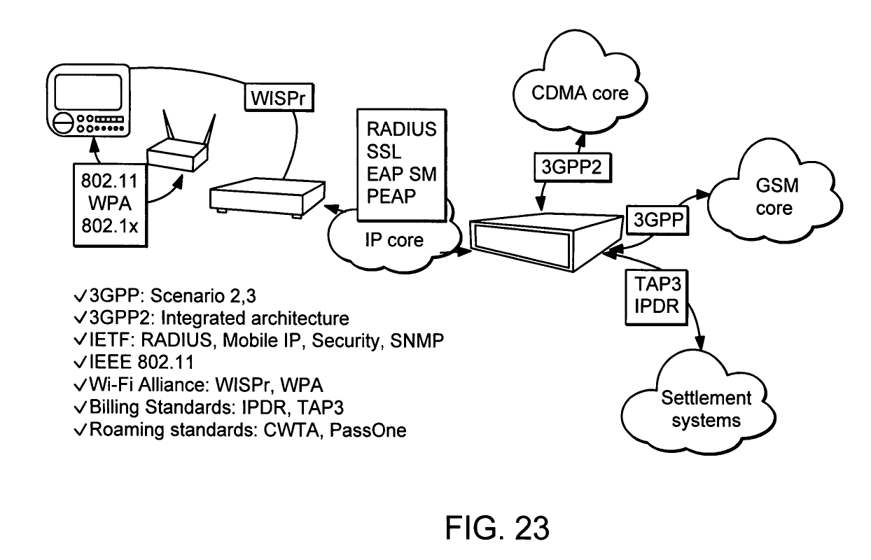

The service delivery product can support a number of standards, in IP, Wi-Fi, and GSM/CDMA environments, as shown, e.g., in FIG. 23. For instance, on the IP side, it can support RADIUS, security protocols such as SSL, and management protocols such as SNMP. It can also be aligned with Wi-Fi specific standards such as WISPr for roaming, 802.1× and WPA for air interface security. It can also support 802.11i when that is standardized. Other Wi-Fi roaming activities such as CWTA and PassOne can also be supported as those standards develop. On the OSS/BSS side, the Subscriber Gateway can support billing standards such as, e.g., TAP3 and GPRS CDR.

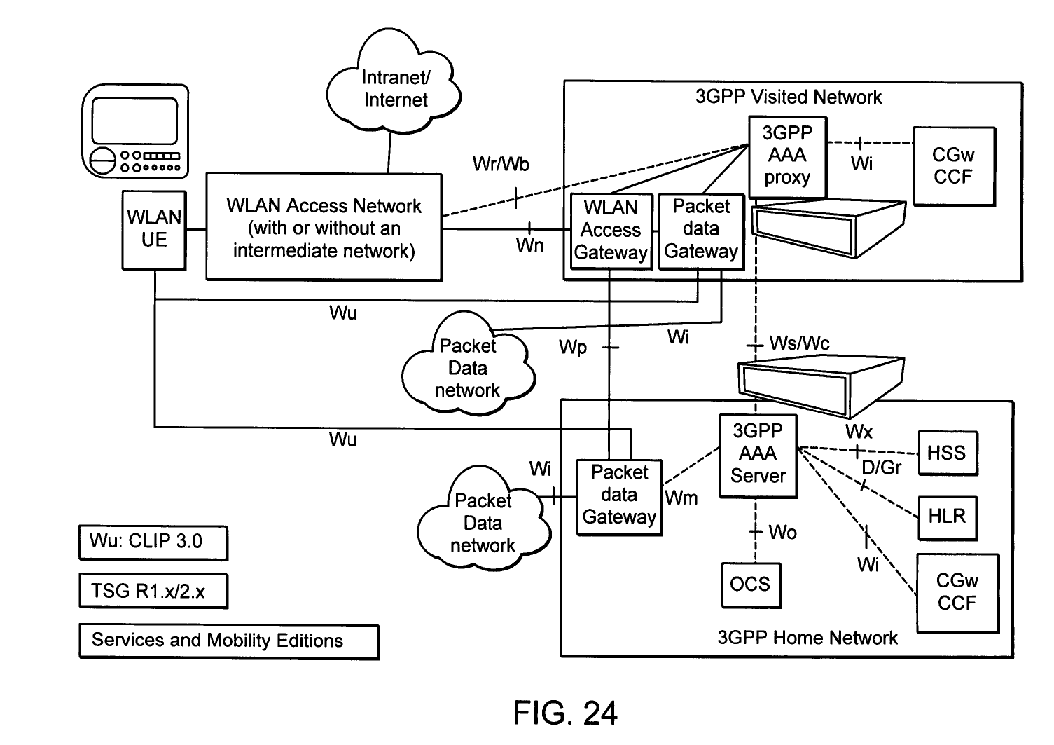

As shown in FIG. 24, the Subscriber Gateway evolution is generally in line with the capabilities outlined in the 3GPP. The service delivery solution also is generally in line with the integrated Wi-Fi/1xRTT solution being defined by the 3GPP2.

Subscriber Gateway: Highlights

In summary, significant features of the Subscriber Gateway in accordande with one or more embodiments include:

1. Architecture

(a) Does not require the addition of infrastructure within hotspots.

(b) Supports Wi-Fi roaming across heterogeneous networks (inbound and outbound roaming across carrier-owned and an array of partner hotspot networks).

(c) Supports Wi-Fi user location and presence management.

(d) Designed with built-in modularity to generally seamlessly support future services.

2. Carrier-class Engineering

(a) Designed to integrate flexibly within service provider environments (GPRS, CDMA, wireline, ISP).

(b) Engineered for security, manageability, and reliability.

(c) Standards compliant (e.g., 3GPP, 3GPP2, IETF, IEEE).

3. Cost Saving.

(a) Centralized approach provides significant deployment and operational cost saving.

(b) Provides turnkey solution to minimize service provider development and customization.

(c) Agnostic to specific hotspot equipment.

Service Manager

The Service Manager is the element of the Wi-Fi Service Delivery Platform that enables the delivery of Wi-Fi services over both carrier-owned and roaming partner networks.

Service Manager: Components and Capabilities

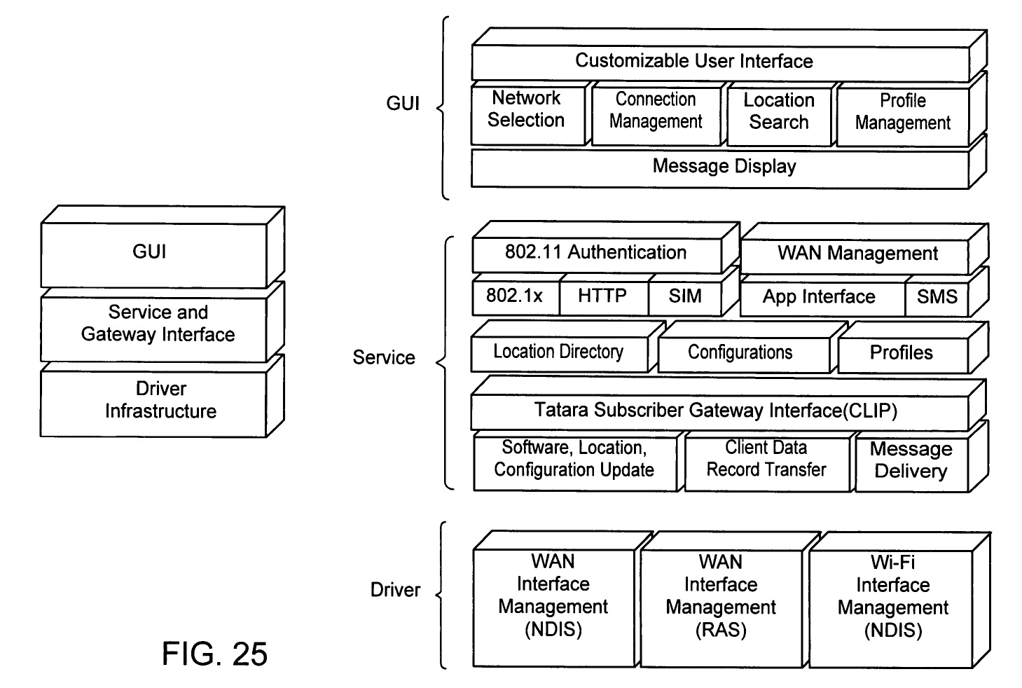

The Service Manager is designed around a modular architecture having three core areas: GUI, Service layer, and Driver layer. The components in these three areas are illustrated in FIG. 25.

GUI Capabilities

Consistent branded user interface—The Service Manager is the only interface required to access any public Wi-Fi service location. The user does not have to use a web browser as part of the access procedure. The Service Manager can be branded by any customer-specific look and feel. The Service Manager also supports ‘dynamic skinning’, which is the ability to load a different ‘look and feel’ at run time. The user interface is designed around a ‘dashboard’ paradigm, which allows the user to use the Service Manager as an application launch pad, in addition to wireless connection management. This also supports an extensible model, where other network connectivity, including WAN, wired, dialup etc. would be supported within the same client UI.

Network and service discovery—The Service Manager can use sophisticated auto-discovery of network and service availability. Specifically, it can scan all available networks, compare them with any pre-configured settings, map networks to service providers, and display appropriate service information.

Configurable Profiles—The Service Manager can support a number of configurable profiles, including service provider configurable profiles, hotspot partner configurable profiles, and user configurable profiles. Service provider configurable profiles allow the service provider to specify any blocked networks, preferred network, authentication schemes to be used, etc. Similarly hotspot partner related profiles include any realms that need to be appended to user identity for the purpose of proxy. Other capabilities include the authentication mechanism supported at a specific hotspot. User configurable profile settings include VPN and application launch, auto connection options, network-specific user credentials, etc.

Location Search: The Service Manager can allow searching of Wi-Fi locations from a hotspot directory, which can also be available off-line. This directory is preferably periodically updated by the service provider. The search capability also provides a link to additional information about each hotspot.

Message Notification and display: The Service Manager has an embedded HTML compatible display area that allows display of service provider messages, location specific messages, prepay notifications, etc. Specifically, the service provider may send periodic service notifications to all subscribers. These messages are captured by the Service Manager and displayed in the notification area. In addition, location-specific messages may be delivered to the user as well. For instance, the location directory may contain pointers to local links that correspond to specific locations. These are displayed in the display area. Further, prepay status notification and top-up can also be controlled through this area.

Service Layer Capabilities

Support for a wide range of Wi-Fi access control mechanisms—The Service Manager can support generally all major versions of HTTP access control in use today and is easily adaptable to variant HTTP implementations. The Service Manager can interface with any hotspot Wi-Fi NAS without requiring any software recompilation and is especially valuable in a roaming centric environment. In addition to HTTP authentication, the Service Manager also supports SIM/802.1x-based access control mechanisms, including PEAP, MD5, MS-CHAP. Other mechanisms such as TLS are on the roadmap.

Network performance and usage statistics—The Service Manager can collect usage, status and network auditing information. This data can be useful in support of network management, fraud monitoring, business development, marketing and customer care needs. This data is communicated to the Subscriber Gateway via the CLIP protocol mentioned earlier.

SMS management: The Service Manager can allow SMS messages to be managed from the client for WAN applications.

Conflicting application check: The Service Manager can also provide enhanced robustness by verifying, at run-time, any conflicting applications that may be running on the user terminal. The user then has the ability to disable any application that might cause conflicting behavior on the client.

Gateway Connectivity: Due to its unique client-server architecture, the Service Manager can enable delivery of a number of advanced capabilities through the Subscriber Gateway. The connection to the gateway can be based on a secure SSL-based communication protocol. By VPN proxy discovery, the CLIP connection also works through a VPN. CLIP enables functions such as collection and delivery of session statistics, collection and delivery of Wi-Fi performance statistics, client software and configuration and location data update, and message delivery. This functionality has also been carved out as a separate SDK that is available for integration into third party clients.

Driver Layer Capabilities

Physical device compatibility—The Service Manager can support all commonly used Wi-Fi NICs, including PCMCIA cards, miniPCI embedded cards, and Centrino-based terminals. The Service Manager can have Plug-N-Play support whereby the underlying Wi-Fi adapters can be inserted/deleted/replaced while the client is active.

WAN support: In addition to Wi-Fi, the Service Manager also supports GPRS and 1xRTT connections as well as tethered phones.

NIC driver management: The Service Manager validates the compatibility of NIC drivers at run time. Specifically, it verifies that the version of driver installed in the terminal is compatible with the supported version. If not, the user is notified of an inconsistency and is provided with the location to retrieve the latest driver.

Prepaid session management: As described in the Subscriber Gateway prepaid capability, the Service Manager can allow disconnect of prepaid sessions if they run over the quota and the user opts to not top up the account.

Advanced Security Features

The Service Manager can provide a number of advanced security capabilities across different layers. On the authentication front, it protects against man-in-the-middle attacks via certificate checking. It also supports end-to-end credential encryption of user credentials. To address data security, it supports interoperation with all major VPN clients and also supports air interface encryption via WEP and WPA. As the 802.11i standard matures, it will be supported in the Service Manager as well. Other security capabilities include a display of the security status of all connections in the Service Manager. This provides security conscious users additional visibility into the security of the connection.

Service Manager: Architecture

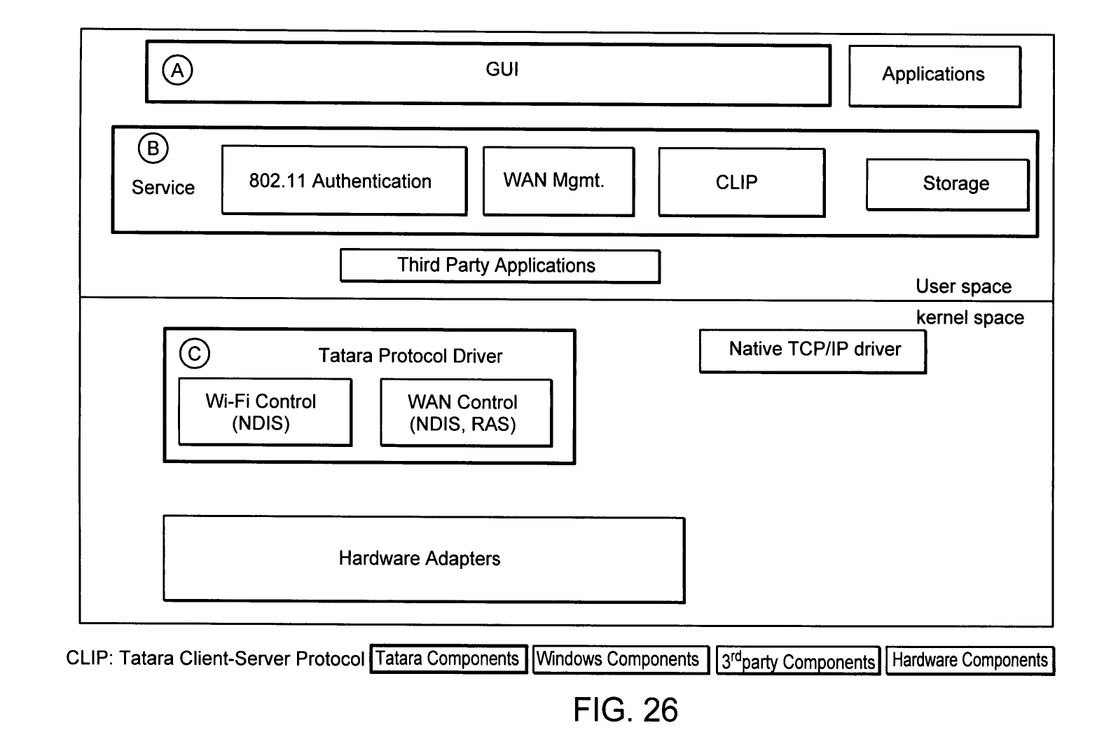

FIG. 26 illustrates the high-level architecture of the Service Manager in accordance with one or more embodiments. As shown in the figure, the GUI and Service layer components run in the user space. The service layer also interfaces with 3rd party applications such as GPRS/1xRTT adapter APIs. The service layer can also interface with other 3rd party applications such as optimization software. The Driver layer runs in the kernel space and supports driver management capabilities. This interfaces with hardware components such as Wi-Fi NICs, GPRS adapters or phones, and SIM readers.

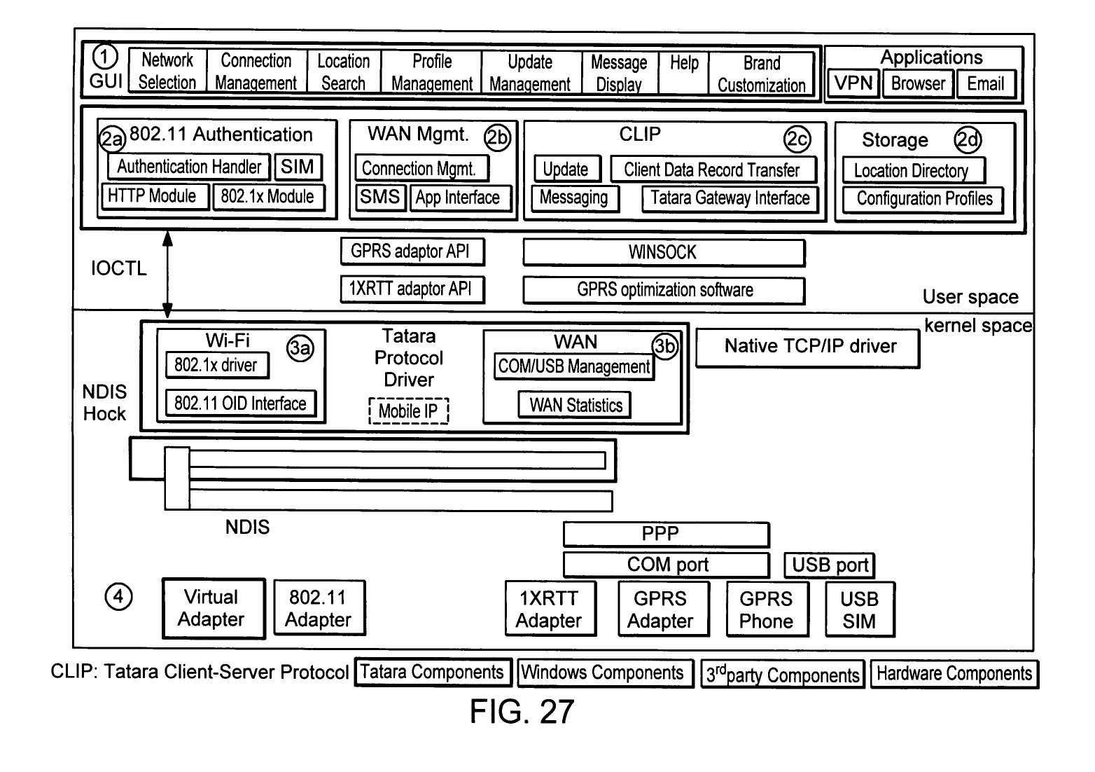

Details of these individual components of the Service Manager are described next with reference to FIG. 27.

1. GUI and Associated Services: The GUI enables the user to view and connect to Wi-Fi and GPRS/1xRTT networks, manage connection profiles, search for network locations, perform automatic software and data updates, and access contextual help.

The GUI component of the Service Manager can run in the user space within an operating system such as Microsoft Windows and is preferably minimally intrusive to the user. It starts as a Tray icon when Windows is launched. The user can bring up the GUI by clicking on the Tray icon, or it opens automatically if the Service Manager detects that service is available. The user can exit/restart the GUI without impacting an active data session. Stored data such as locations or connection profiles are managed automatically by the GUI services module as they are updated by either the user or the service provider. The GUI interacts with the authentication and control module to initiate, maintain, and terminate a Wi-Fi or GPRS/1xRTT session. Finally, the GUI interacts with the ‘CLIP’ module (described below) for automatic software and data updates and to enable the extended service abilities supported in conjunction with the Subscriber Gateway.

The GUI is preferably customized in look and feel to support the service provider's brand requirements. Specifically, the Service Manager can be customized by changing the logo, window titles, background image, and color scheme.

2. Service Layer: This layer forms the communication hub for the kernel drivers and the GUI application. It allows the GUI to exchange information with the underlying kernel modules—enabling authentication credentials to be exchanged and session information such as bytes in/out to be presented to the end user. It also manages authentication for different connections. For Wi-Fi authentication, the authentication protocol is selected based on the user's profile and specific Wi-Fi network support. For example, the authentication module can indicate to the GUI that HTTP is active on the Wi-Fi network resulting in a GUI request for the user name and password. The GUI module sends the information to the authentication module. The authentication module packages the information within the underlying HTIP or 802.1x protocol and sends the information to the underlying protocol driver. In the receive path, an authentication response is received from the protocol driver, parsed, and delivered back to the GUI for presentation.

The GUI and service layer communicate with the kernel mode drivers described below via IOCTL calls. The service layer can have the following four distinct functional modules:

(a) Wi-Fi Authentication via 802.1x or HTTP intercept mechanisms—The Wi-Fi authentication and control module implements a patent-pending intelligent Network Access Server (NAS) discovery mechanism, allowing the client to seamlessly support variants of the HTTP authentication method provided by different NAS vendors. In addition to the HTTP protocols, 802.1x-based protocols including PEAP, EAP-SIM, and PEAP-SIM are supported.

(b) WAN Management—The WAN connection management capabilities include the ability to manage GPRS and 1xRTT connections. This layer also manages SMS services on the GPRS/1xRTT link. This layer can also interface with other 3rd party GPRS applications such as optimization software and adaptor SDKs.

(c) Client to Subscriber Gateway Communication (CLIP)—In deployments where the system's backend server product—the Subscriber Gateway—has been deployed in conjunction with the Service Manager, this module provides a secure communication mechanism between the Subscriber Gateway and the Service Manager. These capabilities include automated software update, location directory update, collection and delivery of session logs, Wi-Fi session information, etc.

(d) Stored Data (location database, profiles, etc.)—The location and profile data used by the Service Manager are stored as text files within the client. Further, service provider managed profiles are also stored in the client. All the configuration data can be updated through an automated mechanism using the Subscriber Gateway.

3. Kernel Drivers—The kernel drivers can run in the Microsoft Windows kernel space. These drivers allow management of Wi-Fi and WAN network interfaces. The functionality is grouped into three areas: Wi-Fi management drivers manage Wi-Fi connections, WAN management drivers manage WAN connections, and a Virtual adapter enables cross network mobility using mobile IP. The Service Manager currently supports basic mobile IP modules and will be expanded in future releases to support additional mobile IP support.

Wi-Fi Management

Two drivers implement the 802.1x protocol and the HTTP intercept functionality. These drivers also provide hooks for mobile IP.

Protocol Driver

The protocol driver serves two Wi-Fi related functions: (a) it provides transport for 802.1x packets between the authentication module and the 802.11 adapter. This driver communicates with the 802.11 adapter using NDIS 5.1 OIDs. (b) it provides mobile IP functionality, determining the appropriate active adapters, registration, etc.

NDIS Hook Driver

The NDIS hook driver intercepts packets and communicates them to the Protocol Driver. This architecture also enables Mobile IP.

WAN Management: The WAN management capabilities allow the management of WAN interfaces, including GPRS and 1xRTT adapters as well as phones. These can be managed by two methods. For adapters that support NDIS, the protocol driver described earlier is used to interface with WAN cards. For phones or adapters based on a RAS model, the WAN management module supports functionality through RAS (dialup) or USB support.

Virtual Adapter: The Virtual adapter and the hook driver (described earlier) provide the foundation for Mobile IP support in the Service Manager.

Service Manager: Advantageous Features

The Service Manager is designed ground up to support wireless data services. It provides a number of advantageous features that enhance the overall wireless service experience.

1. Branded dashboard user interface

2. Multi-interface support: Advanced support for multiple network interfaces, including Wi-Fi, GPRS, and 1xRTT in different form factors, including PCMCIA, miniPCI, embedded, serial, and dialup.

3. Rich set of Wi-Fi authentication methods: Supports a number HTTP/S and 802.1x methods, including SIM, PEAP, and MD5.

4. Auto-discovery of Wi-Fi authentication method: Enables automated discovery of the type of authentication method to use (802.1x or HTTP), and within each type, it detects the appropriate protocol to be used. Specifically, for HTTP authentication types, it supports authentication via different NAS devices.

5. Auto-discovery of Wi-Fi service provider networks: Automatically discovers service provider or eligible partner networks before sending user credentials, ensuring subscriber identity protection. Also supports selection of preferred networks in multi-provider environments.

6. Location-specific branding: Allows display of location or partner specific information through a powerful location directory.

7. Service provider and user configurable profiles: Allows service providers and users to configure service parameters, including preferred roaming networks, network connection priority, auto application launch, etc.

8. NIC driver and conflicting application check: This provides enhanced robustness as well as carrier-grade management capabilities.

9. Security status display: The Service Manager displays the security status of individual connections within the Service Manager, providing additional visibility into the Wi-Fi connection.

Further, if deployed in conjunction with the Subscriber Gateway, the Service Manager provide a number of additional advanced value-added services.

1. Improved security through credential encryption: Encrypts user credentials with a public key of the Subscriber Gateway to protect credentials, especially in roaming networks.

2. Detailed diagnostics support: Supports collection of Wi-Fi session statistics for improved visibility into Wi-Fi networks, also improving diagnostics and customer care.

3. Automated update of software, location directory, configuration profiles: Allows easy management of the software components via automated update.

4. Location directory management: Allows configuration, distribution, and update of the location directory through an automated mechanism.

5. Messaging support: Allows delivery of service provider or partner or location specific messages from the Subscriber Gateway.

6. VPN Interoperability: Supports communication with the Subscriber Gateway by seamlessly interoperating with VPNs.

Note that the Service Manager is designed around a modular architecture. Further, the software is designed so that components may be ‘carved out’ to form a plug-in that can be integrated into other clients. Specifically, a candidate for a plug-in is the CLIP module. Recall that the CLIP module allows the Service Manager to interface with the Subscriber Gateway to provide a set of unique capabilities.

Logout Process

The following is an outline of the steps involved in the logout process in accordance with one or more embodiments:

When a session is initially authenticated, the Service Manager automatically captures the URL for the hotspot log-off as part of the http authentication exchange with the hotspot access controller (NAS). The Service Manager also captures the ‘session ID’ that is returned by the NAS as part of the login message. (Note: Some hotspot operators—including Wayport—associate sessions with a random session ID. In other cases the session ID is the user's MAC address.)

The captured logout URL and session ID are stored in memory by the client. This may be a ‘local’ URL (e.g. on the local network and not Internet accessible)—as otherwise the network is more vulnerable to remote denial of service attacks by accepting session termination messages from any Internet IP address.

If a user who does not have an active VPN session underway pushes the logout button on the client, the client automatically does an HTTP Post to this URL and the session is terminated. (Note: The statement above assumes that the service provider has not implemented an L2TP tunnel in a roaming environment. In this case, the logout issues would be the same as for the VPN case even if the user was not running a VPN.)

If the user has started a VPN, then a simple post to this URL will fail if the URL is on a local network (as described above) unless the VPN client supports and has split tunneling enabled—which from experience is a small minority of the time. This failure is due to the fact that the URL is on the ‘local’ network and the post is effectively initiating from the enterprise (or wherever the VPN tunnel is terminating).

The way the present system addresses this in the case that the user is in a service provider-owned hotspot is as follows:

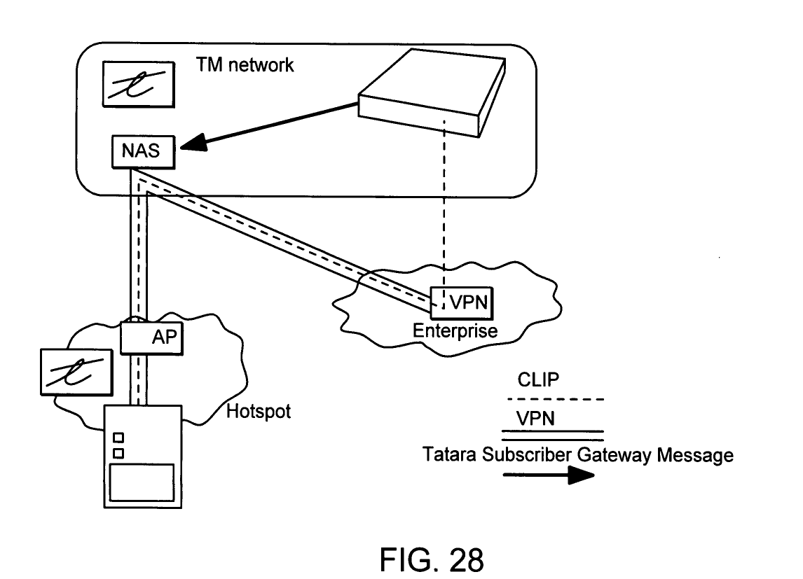

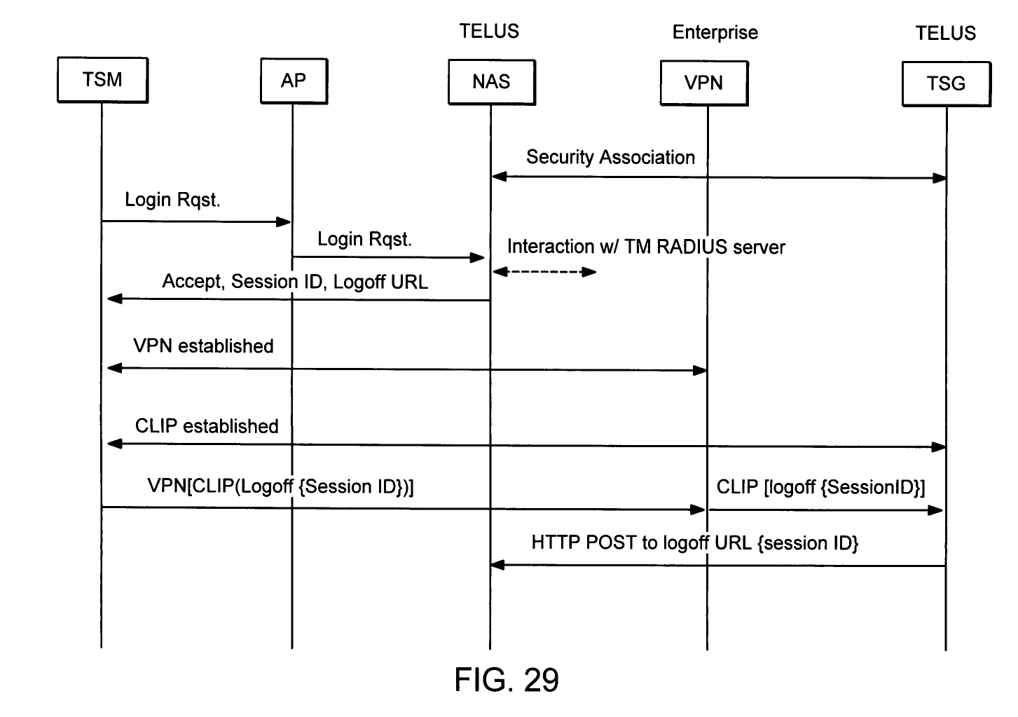

Referring to FIGS. 28 and 29, the Subscriber Gateway and the service provider NAS share a security association by either being part of the private network or via a tunnel between the Subscriber Gateway and the NAS device.

Any time a VPN session is initiated, the Service Manager automatically re-establishes the CLIP session back to the Subscriber Gateway. This session traverses through the VPN, through any enterprise proxy servers and back out to the Subscriber Gateway (over the Internet). Note that the user's data traffic does not flow through the CLIP session. This is used only for specific value-added functionality delivered through the Wi-Fi Service Delivery Platform.

When the user then pushes the logout button, the client—knowing that the user is running a VPN—forwards the logout request—which includes both the logout URL and the session ID that have been stored—to the Subscriber Gateway through the CLIP connection. Note: If the user terminates the VPN session prior to pressing the logout button the Service Manager recognizes this and knows to skip this step and do a simple post to the URL.

The Subscriber Gateway, on receiving the logout request from the client, posts to the appropriate URL with the session ID to terminate the session. Because the Subscriber Gateway and the NAS share a security association the logout URL is accessible.

In the case that the user is not in a service provider-owned hotspot, the situation is somewhat different—and may vary slightly from partner to partner. In general, the logout can be completed successfully through one or more of the following methods on a case-by-case basis as noted:

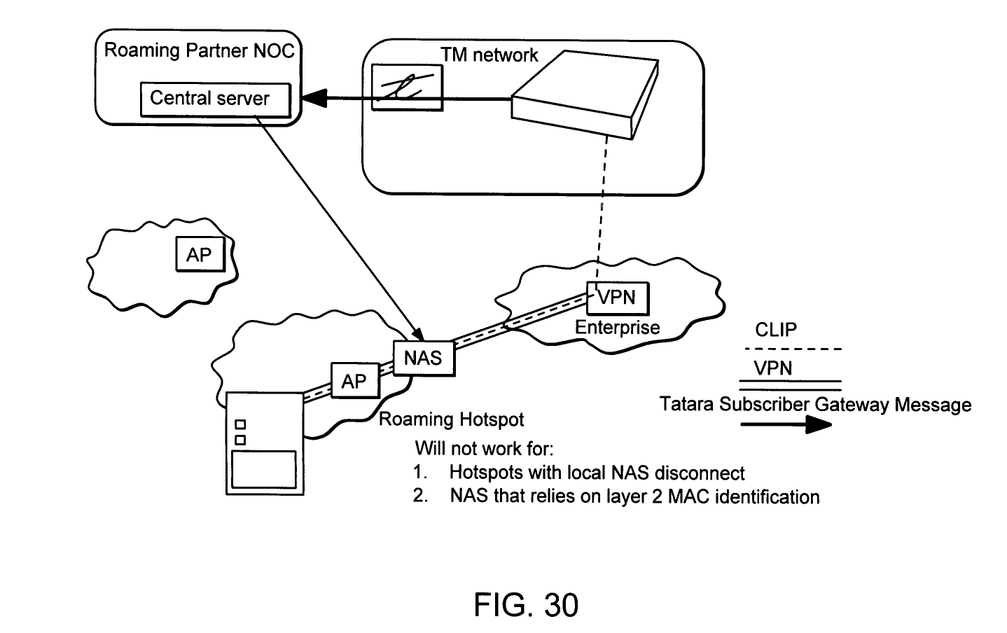

Referring to FIG. 30, if the partner's logout URL is Internet accessible, the Post to this URL (through the VPN tunnel and enterprise proxy server) will successfully terminate the session.

A partner with a large network may deploy a central management system for all of their hotspots where the logout messages are sent. For example, Wayport, the largest independent hotspot network operator in North America, has configured their network this way. In this case, the Subscriber Gateway and the central Wayport server can share a security association via a tunnel. In this case, the logout can work as described above in the TELUS-owned network case (where it is routed through the Subscriber Gateway).

A larger partner who has not deployed a central management system could still have a central private network access to the distributed NAS devices within their network. In this case, the partner could affect the logout from a central point in their network which connects to the Subscriber Gateway via a tunnel. (This would require some work by the partner—but it is something the partner may need to do to facilitate roaming—particularly if there are other local services they want to make accessible to inbound roaming users.) Note: This is problematic if there is not a central access mechanism—and for smaller partners—due to the number of tunnels that would need to be configured to reach every hotspot NAS.

In other cases, the Service Manager can programmatically terminate the VPN prior to posting the logout or warn the user to close the VPN before logging out.

The service delivery platform in accordance with one or more embodiments of the invention thereby enables retail service providers to offer Wi-Fi services with a number of advantages.

The service delivery platform can support a predominantly roaming Wi-Fi environment through an architecture that offers hardware-agnostic hotspot support, where no additional hardware or software is needed to be deployed in Wi-Fi networks, making it possible for service providers to integrate heterogeneous roaming partner networks into their existing footprint.

The service delivery platform can also enable backhaul-agnostic hotspot support, where no dedicated backhaul is provided at Wi-Fi locations, enabling service providers to quickly and cost-effectively deploy a Wi-Fi service without the costs and delays involved with provisioning and operating dedicated networks.

In addition, an easy-to-use UI can be provided for managing roaming partnerships, including maintenance of RADIUS information and Wi-Fi location management.

The platform can also support end-to-end security through a combination of methods that offer protection of user credentials through unique use of certificates in a client-server architecture.

The platform can also support an enhanced customer experience by (1) providing a consistent branded user experience in heterogeneous network environments; and (2) providing mechanisms for delivery of location and presence based services by managing user reachability information, even when the user runs a VPN.

The platform can support a highly manageable solution that offers (1) visibility and manageability of a secure carrier-class platform via SNMP, HTTPS, and CLI, and (2) mechanisms for customer care and diagnostics for customer management.

Having described preferred embodiments of the present invention, it should be apparent that modifications can be made without departing from the spirit and scope of the invention.

1. A method for managing usage of a plurality of local area networks by a plurality of subscribers associated with a service provider, said subscribers having terminals for accessing said local area networks, said terminals each having a client program for communicating with a service provider network, for each subscriber desiring to access a local area network, the method comprising the steps of:
(a) receiving at a gateway at the service provider network a request for authenticating a subscriber desiring access to said local area network, said request containing subscriber credentials for the subscriber desiring access to said local area network;
(b) authenticating the subscriber based on said subscriber credentials and information relating to said subscriber previously stored in a subscriber database;
(c) authorizing said local area network to grant access to said subscriber when said subscriber is authenticated;
(d) establishing a link between said gateway and a client program on a terminal operated by said subscriber;
(e) collecting session information through said link;
(f) receiving information on local area network usage by said subscriber; and
(g) transmitting said information on local area network usage to a billing system for billing of usage by said subscriber.

2. The method of claim 1 wherein said terminals are laptops, personal digital assistants, or smart phones.

3. The method of claim 1 wherein said service provider is a GSM operator, a CDMA operator, a cable operator, or a wireline service provider.

4. The method of claim 1 wherein step (a) comprises receiving said request from said local area network using RADIUS or DIAMETER protocols.

5. The method of claim 1 wherein said information transmitted in step (g) comprises RADIUS data augmented with location and service plan information and converted to a format of said service provider.

6. The method of claim 1 wherein said local area networks are wireless local area networks.

7. The method of claim 6 wherein said local area networks are Wi-Fi or WiMAX networks.

8. The method of claim 1 wherein step (a) comprises receiving a request for authenticating a subscriber from a network access server at said local area network.

9. The method of claim 1 wherein said subscriber credentials are encrypted.

10. The method of claim 1 further comprising determining a service plan for said subscriber from said subscriber database.

11. The method of claim 1 wherein said session information includes a client session log containing session information collected on termination of a session.

12. The method of claim 1 wherein said session information includes information on the location of the subscriber.

13. The method of claim 12 further comprising pushing a location-aware message to the terminal using the link established at step (d) based on the location of the subscriber.

14. The method of claim 1 wherein said session information includes performance metrics for use in monitoring network performance.

15. The method of claim 1 wherein said session information includes performance metrics for use in establishing service level agreements between operators of said local area networks and said service provider.

16. The method of claim 1 wherein said session information includes performance metrics for use in customer support and diagnostics to obtain visibility into a subscriber session.

17. The method of claim 1 further comprising the step of auditing said information received in step (f) from said local area network by comparing said information with said session information collected in step (e).

18. The method of claim 1 wherein said local area network contains no hotspot component dedicated to any service provider.

19. The method of claim 1 wherein data is transmitted between said gateway and said local area network without using a dedicated backhaul between the gateway and the local area network.

20. The method of claim 1 wherein data is transmitted between said gateway and said local area network over a public IP network.

21. The method of claim 1 further comprising pushing data to the terminal using the link established at step (d).

22. The method of claim 21 wherein said pushed data comprises advertising.

23. The method of claim 21 wherein said pushed data comprises an updated client program.

24. The method of claim 1 further comprising providing an application to the subscriber using the link established at step (d).

25. The method of claim 24 wherein said application is a messaging application or voice application.

26. The method of claim 1 further comprising performing real-time diagnostics over said link established at step (d).

27. The method of claim 1 wherein said link established at step (d) is maintained even when said subscriber is running a virtual private network.

28. The method of claim 1 wherein the subscriber database is a home location register (HLR) or an lightweight directory access protocol (LDAP) database.

29. The method of claim 1 wherein said subscriber database is an home location register (HLR), and wherein said gateway acts as a visited location register (VLR).

30. The method of claim 1 further comprising using the link established at step (d) to control access to said local area network by said subscriber.

31. The method of claim 30 wherein said subscriber has a pre-paid account, and wherein access to said local area network is controlled by terminating a session when the pre-paid account has been depleted.

32. The method of claim 1 further comprising using said link established at step (d) to replenish an account instead or to alert the subscriber of account depletion.

33. The method of claim 1 wherein information relating to said subscriber previously stored in a subscriber database comprises information obtained in connection with another service offered by the retail service provider to the subscriber.

34. The method of claim 1 wherein said link is a secure link between said gateway and said client program.

35. The method of claim 1 wherein said link is an SSL link.

36. The method of claim 1 further comprising collecting information about said local area networks, said information comprising data on local area network location, type, authentication mechanism or owner.

37. The method of claim 36 further comprising collecting said information about said local area networks in a location directory, and making said directory available to said plurality of subscribers through said client programs.

38. A gateway for managing usage of a plurality of local area networks by a plurality of subscribers associated with a service provider, said subscribers having terminals for accessing said local area networks, said terminals each having a client program for communicating with said gateway, the gateway comprising:
a first interface module for communicating with said local area networks;
a second interface module for communicating with client programs on terminals operated by subscribers accessing said local area networks;
a third interface module for communicating with infrastructure of said service provider; and
a session manager for receiving through said first interface module requests for authenticating subscribers desiring access to said local area networks, said requests containing subscriber credentials for said subscribers, said session manager authenticating subscribers based on their subscriber credentials and information relating to said subscribers previously stored in a subscriber database through said third interface module, and said session manager authorizing local area networks through said first interface module to grant access to authenticated subscribers,
said session manager also receiving from said local area networks through said first interface module information on local area network usage by said subscribers, said session manager transmitting said information on local area network usage to a billing system through said third interface module for billing of usage by said subscribers,
said session manager also collecting session information through said second interface module from said client programs on said terminals accessing said local area networks.

39. The gateway of claim 38 wherein said terminals are laptops, personal digital assistants, or smart phones.

40. The gateway of claim 38 wherein said service provider is a GSM operator, a CDMA operator, a cable operator, or a wireline service provider.

41. The gateway of claim 38 wherein said requests for authenticating subscribers are received from said local area networks using RADIUS or DIAMETER protocols.

42. The gateway of claim 38 wherein said information transmitted to said billing system comprises RADIUS data augmented with location and service plan information and converted to a format of said service provider.

43. The gateway of claim 38 wherein said local area networks are wireless local area networks.

44. The gateway of claim 38 wherein said local area networks are Wi-Fi or WiMAX networks.

45. The gateway of claim 38 wherein said first interface module communicates with network access servers at said local area networks.

46. The gateway of claim 38 wherein said subscriber credentials are encrypted.

47. The gateway of claim 38 wherein said session manager also determines a service plan for said subscriber from said subscriber database.

48. The gateway of claim 38 wherein said session information includes a client session log containing session information collected on termination of a session.

49. The gateway of claim 38 wherein said session information includes information on the location of the subscriber.

50. The gateway of claim 49 wherein the session manager pushes a location-aware message to the terminal using links established between the second interface module and the client programs on the terminals based on said information on the location of the subscriber.

51. The gateway of claim 38 wherein said session information includes performance metrics for use in monitoring network performance.

52. The gateway of claim 38 wherein said session manager also audits said information on local area network usage by said subscribers by comparing said information with said session information.

53. The gateway of claim 38 wherein said local area network contains no hotspot component dedicated to any service provider.

54. The gateway of claim 38 wherein data is transmitted between said gateway and said local area networks without using dedicated backhauls between the gateway and the local area networks.

55. The gateway of claim 38 wherein data is transmitted between said gateway and said local area networks over a public IP network.

56. The gateway of claim 38 wherein said session manager further pushes data to the terminals using a link established between the second interface module and the client programs on the terminals.

57. The gateway of claim 56 wherein said pushed data comprises advertising.

58. The gateway of claim 56 wherein said pushed data comprises an updated client program.

59. The gateway of claim 38 wherein the session manager further provides an application to the subscriber using links established between the second interface module and the client programs on the terminals.

60. The gateway of claim 59 wherein said application is a messaging application or voice application.

61. The gateway of claim 38 wherein the session manager further performs real-time diagnostics using links established between the second interface module and the client programs on the terminals.

62. The gateway of claim 38 wherein said links established between the second interface module and the client programs on the terminals are maintained even when subscribers are running virtual private networks.

63. The gateway of claim 38 wherein said client program and said gateway communicate to replenish an account or to alert the subscriber of account depletion.

64. The gateway of claim 38 wherein the subscriber database is an HLR or an LDAP database.

65. The gateway of claim 38 wherein said subscriber database is an home location register (HLR), and wherein said gateway acts as a visited location register (VLR).

66. The gateway of claim 38 wherein the session manager uses links established between the second interface module and the client programs on the terminals to control access to said local area networks by said subscribers.

67. The gateway of claim 66 wherein for subscribers having a pre-paid account, the session manager controls their access to said local area networks by terminating a session when a pre-paid account has been depleted.

68. The gateway of claim 38 wherein information relating to said subscriber previously stored in a subscriber database comprises information from another service offered by the retail service provider to the subscriber.

69. The gateway of claim 38 wherein said gateway is deployed centrally in a service provider network.

70. The gateway of claim 38 wherein said requests for authenticating subscribers is made using 802.1x or http protocol.

71. The gateway of claim 38 wherein said session information includes performance metrics for use in establishing service level agreements between operators of said local area networks and said service provider.

72. The gateway of claim 38 wherein said session information includes performance metrics for use in customer support and diagnostics to get visibility into a subscriber session.

73. The gateway of claim 38 wherein said gateway and said client program communicate over a secure link.

74. The gateway of claim 73 wherein said link is an SSL link.

75. The gateway of claim 38 wherein said session manager collect information about said local area networks, said information comprising information on local are network location, type, authentication mechanism or owner.

76. The gateway of claim 75 wherein said gateway collects said information about said local area networks in a location directory, and makes said directory available to said plurality of subscribers.

77. A method of accessing one of a plurality of local area networks by a subscriber operating a terminal, said subscriber associated with a service provider, the method for accessing a local area network comprising the steps of:
(a) transmitting to the local area network a request for accessing the local area network, said request including subscriber credentials for said subscriber, said local area network transmitting to a gateway at the service provider network a request containing the subscriber credentials for authenticating the subscriber, said gateway authenticating the subscriber based on said subscriber credentials and information relating to said subscriber previously stored in a subscriber database, said gateway authorizing said local area network to grant access to said subscriber when said subscriber is authenticated;
(b) accessing said local area network when said subscriber is authorized to access said local area network;
(c) establishing a link between a client program on said terminal operated by said subscriber and said gateway; and
(d) transmitting session information through said link to said gateway.

78. The method of claim 77 wherein said terminals are laptops, personal digital assistants, or smart phones.

79. The method of claim 77 wherein said service provider is a GSM operator, a CDMA operator, a cable operator, or a wireline service provider.

80. The method of claim 77 wherein transmitting to a gateway comprises using RADIUS or DIAMETER protocols.

81. The method of claim 77 wherein said local area networks are wireless local area networks.

82. The method of claim 81 wherein said local area networks are Wi-Fi or WiMAX networks.

83. The method of claim 77 wherein said request for authenticating a subscriber is transmitted to said gateway from a network access server at said local area network.

84. The method of claim 77 wherein said subscriber credentials are encrypted.

85. The method of claim 77 wherein said session information includes a client session log containing session information collected on termination of a session.

86. The method of claim 77 wherein said session information includes information on the location of the subscriber.

87. The method of claim 77 further comprising receiving a location-aware message from the gateway through the link established at step (c) based on said location of the subscriber.

88. The method of claim 77 wherein said session information includes performance metrics for use in monitoring network performance.

89. The method of claim 77 wherein said local area network contains no hotspot component dedicated to any service provider.

90. The method of claim 77 further comprising receiving data from the gateway through the link established at step (c).

91. The method of claim 90 wherein said data comprises advertising.

92. The method of claim 90 wherein said data comprises an updated client program.

93. The method of claim 77 further comprising receiving an application from the gateway through the link established at step (c).

94. The method of claim 93 wherein said application is a messaging application or voice application.

95. The method of claim 77 wherein said link established at step (c) is maintained even when said subscriber is running a virtual private network.

96. The method of claim 77 wherein access to said local area network by said subscriber is controlled by said gateway using the link established at step (c).

97. The method of claim 96 wherein said subscriber has a pre-paid account, and wherein access to said local area network is controlled by the gateway by terminating a session when the pre-paid account has been depleted.

98. The method of claim 77 wherein information relating to said subscriber previously stored in a subscriber database comprises information from another service offered by the retail service provider to the subscriber.

99. The method of claim 77 wherein said client program checks driver compatibility on said terminal.

100. The method of claim 77 wherein said client program transmits a preconfigured profile of said subscriber to said local area network.

101. The method of claim 77 wherein said client program provides a directory to said user of accessible local area networks.

102. The method of claim 101 wherein said client program can prioritize said local area networks based on one or more factors including local area network location, preferred local area networks, and network transmission speeds.

103. The method of claim 77 wherein said client program can access GPRS, CDMA, dial and Ethernet networks.

104. The method of claim 77 wherein said client program can interface with local area network equipment for http authentication.

105. The method of claim 77 wherein said client program displays session information or pushed messages on said terminal.

106. The method of claim 77 wherein said client program is plugged into a client interface of a party other than said service provider.

107. The method of claim 77 wherein said session information includes performance metrics for use in establishing service level agreements between operators of said local area networks and said service provider.

108. The method of claim 77 wherein said session information includes performance metrics for use in customer support and diagnostics to get visibility into a subscriber session.

109. The method of claim 77 wherein said link is a secure link between said gateway and said client program.

110. The method of claim 77 wherein said link is an SSL link.

111. The method of claim 1 wherein said subscriber is authenticated based on SIM authentication information.

112. The method of claim 1 wherein said subscriber is authenticated based on SIM authentication information sent from said client program to said gateway, and by a one time password provided by said gateway to said client program.

113. The gateway of claim 38 wherein said subscriber is authenticated based on SIM authentication information.

114. The gateway of claim 38 wherein said subscriber is authenticated based on SIM authentication information sent from said client program to said gateway, and by a one time password provided by said gateway to said client program.

115. The method of claim 77 wherein said subscriber is authenticated based on SIM authentication information.

116. The method of claim 77 wherein said subscriber is authenticated based on SIM authentication information sent from said client program to said gateway, and by a one time password provided by said gateway to said client program.

117. A method for managing usage of a plurality of local area networks by a plurality of subscribers associated with a service provider, said subscribers having terminals for accessing said local area networks, said subscribers also having cell phones having MSISDN information, for each subscriber desiring to access a local area network, the method comprising the steps of:
(a) receiving at a gateway at the service provider network a request for authenticating a subscriber desiring access to said local area network, said request containing MSISDN information for the subscriber desiring access to said local area network;
(b) validating the subscriber based on said MSISDN information and information relating to said subscriber previously stored in a subscriber database;
(c) transmitting a one time password to a cell phone operated by said subscriber;
(d) receiving from a terminal operated by said subscriber said one time password;
(e) authenticating said subscriber based on said one time password;
(f) authorizing said local area network to grant access to said subscriber when said subscriber is authenticated;
(g) receiving information on local area network usage by said subscriber; and
(h) transmitting said information on local area network usage to a billing system for billing of usage by said subscriber.
